(19) United States
(12) Patent Application Publication
(10) Pub. No.: US 2026/0330858 A1
(43) Pub. Date: Oct. 22, 2026

(54) CONFIGURABLE HANDWRITING-RECOGNITION FRAMEWORK

(71) Applicant: Ancestry.com Operations Inc., Lehi, UT (US)

(72) Inventors: Caleb Mark Skidmore, Highland, UT (US); Jess DeWaine Anderson, South Jordan, UT (US); Eric Glen Burdett, Provo, UT (US); Masaki Stanley Fujimoto, Provo, UT (US); Siteng Chen, Provo, UT (US); Kalyan Chakravarthi Murahari, San Francisco, CA (US); MJ Ghorbani, San Francisco, CA (US); Candace Lynette Lavaka, Eagle Mountain, UT (US); Adam Johnson, Springville, UT (US); Sravan Kumar Aravapalli, Ashland, MA (US)

(21) Appl. No.: 19/648,912

(22) Filed: Apr. 15, 2026

Related U.S. Application Data
(60) Provisional application No. 63/790,560, filed on Apr. 17, 2025.

(51) Int. Cl. G06V 30/19; G06F 16/23; G06V 10/82; G06V 30/22; G06V 30/30

(52) U.S. Cl. CPC G06V 30/19113; G06F 16/2379; G06V 30/1916; G06V 30/19173; G06V 30/22; G06V 30/30; G06V 10/82

(57) ABSTRACT

The present disclosure is directed toward systems, methods, and non-transitory computer-readable media a configurable handwriting-recognition framework that can be constructed according to one or more aspects of a digital image that depicts textual content. The disclosed systems can insert model socket-specific models into model sockets of the configurable handwriting-recognition framework to perform distinct functions to generate a genealogical record from a handwriting image. Further, the disclosed systems can use model-socket adapters to standardize outputs of the model socket-specific models to create a uniform workflow. In addition, the disclosed systems can modify a genealogical database according to the genealogical record.

### CROSS REFERENCE TO RELATED APPS

This application claims the benefit of, and priority to, U.S. Provisional Application No. 63/790,560 entitled “CONFIGURABLE HANDWRITING-RECOGNITION FRAMEWORK” filed Apr. 17, 2025, the contents of which are incorporated by reference herein in their entirety.

### BACKGROUND

Recent years have seen significant developments in artificial intelligence (AI) software across an enormous array of tasks, including classifying, segmenting, and transcribing digital content, such as handwriting images. Based on the ever-increasing capabilities of machine-learning models, such as large language models, some existing systems incorporate models into programming architecture, data-analysis pipelines, or other data-processing systems. For example, some existing systems use large language models to transcribe content, such as handwriting, in images. Despite these advances, existing systems exhibit a number of problems, particularly in relation to operational flexibility, accuracy, and efficiency.

As just suggested, many existing systems are operationally inflexible. While existing systems may incorporate various models to perform handwriting recognition (e.g., handwriting image classification and text extraction), such processes are generally done on a piecewise, case-by-case basis, with each model limited to a specific use case or a particular type of content item (e.g., a collection of journal entries versus a collection of birth certificates). Indeed, handwriting images come in a variety of types and layouts and contain a variety of content. Traditional approaches generally involve constructing and utilizing niche models separately from one another. In many of these traditional systems, the niche models are incompatible with one another (and thus incapable of sharing data).

Due at least in part to their operational inflexibility, many existing handwriting-recognition systems are inaccurate. The highly individualized nature of existing systems makes them susceptible to inaccurate text extraction due to small changes in input parameters and/or slight variations in image format (e.g., a change in a type of document or a format of a document that affects what and where information is presented). Further, many handwriting images depict documents that are degraded or otherwise worn from the passage of time, and the hyper-specialized approach of prior systems renders the models inadequate for (or entirely incapable of) extracting handwriting from images that may not conform to recognizable formats or layouts. Worse, such existing systems may not have any capability of accurately predicting accuracy, leading downstream recipients of the data generated from such systems to erroneously rely upon the data as though it were accurate, leading, in the example of genealogical research services, to highly emotionally fraught misconceptions regarding family history. Moreover, language changes over time, thus negatively impacting the ability of the fixed models existing systems to adapt to extracting handwriting from images.

Additionally, existing systems are computationally inefficient. The specialized nature of models in existing systems requires frequent training and retraining for even slight changes in image layout or format. Indeed, the models of existing systems are often trained to extract handwriting from images without discretizing the processes involved (e.g., where layout-detection is separate from entity-extraction). Thus, even if the change to an image is a minor update to a particular data label (e.g., where a government updates a birth certificate format from indicating “birthplace” to indicating “place of birth”) while the layout remains the same, existing systems often require retraining the entire model from the ground up. Such repeated training of large, fully featured models consumes an excessive amount of computational resources (such as processing power, memory, and storage) that could otherwise be preserved with a more efficient system. Further, existing systems do not provide modalities for assessing the cost from a particular configuration of component models, further driving up costs as users of the systems apply expensive, inaccurate, and/or inefficient tools to address their particular use cases.

Within the domain of handwriting recognition but certainly not limited thereto, a major problem with machine learning and artificial intelligence in general is the inaccessibility of machine learning tools to the uninitiated. Data scientists are well-equipped to build, train, and deploy machine learning models, but these professionals are in critically short supply. Laypeople, lacking the esoteric training and experience in machine learning models that are the special province of data scientists, are likely to find themselves unable to avail themselves of the benefits that machine learning might otherwise be able to bring to bear on problems that they face, and therefore must, at great cost, engage data scientists to build machine learning tools for them. Worse, laypeople who attempt to build machine learning tools without the oversight of an invested data scientist are at risk of building bad models using bad data and that give bad, misleading results without even realizing it. Data scientists, for their part, may tire of retraining and tweaking machine learning models to solve similar problems in a particular field, preferring instead to spend their limited time and resources on more cutting-edge research and development. There is, therefore, an urgent need for an improved machine learning deployment approach that democratizes the benefits of machine learning outside of the exclusive efforts of data scientists.

### SUMMARY

This disclosure describes one or more embodiments of systems, methods, and non-transitory computer-readable storage media that provide benefits and/or solve one or more of the foregoing and other problems with the art. In particular, the disclosed systems generate a configurable handwriting-recognition framework that includes model-specific sockets for different models, such as large language models and/or image processing models, among others. The disclosed systems can insert different types of models into the sockets of the configurable handwriting-recognition framework to utilize the configurable handwriting-recognition framework to streamline performance of different tasks relating to processing a genealogical record, such as a handwriting image. To illustrate, the disclosed systems can insert models into the configurable handwriting-recognition framework to perform tasks such as image segmentation, transcription, entity-extraction, and relationship-extraction. Further, the disclosed systems connect the model-specific sockets utilizing model-socket adapters to standardize outputs of different models input into corresponding sockets of the configurable handwriting-recognition framework. Accordingly, the disclosed systems can utilize the configurable handwriting-recognition framework to construct different types of pipelines to process different types of handwriting images. Specifically, the disclosed systems can utilize the configurable handwriting-recognition framework to generate genealogical records from handwriting images.

### BRIEF DESCRIPTION OF THE DRAWINGS

This disclosure will describe one or more example implementations of the systems and methods with additional specificity and detail by referencing the accompanying figures. The following paragraphs briefly describe those figures.

FIG. 1 illustrates a schematic diagram of an example environment of a handwriting-recognition pipeline system in accordance with one or more embodiments.

FIG. 2 illustrates an overview of utilizing a configurable handwriting-recognition framework to generate a genealogical record in accordance with one or more embodiments.

FIG. 3 illustrates a configurable handwriting-recognition framework that includes a plurality of model sockets corresponding to a plurality of model types in accordance with one or more embodiments.

FIG. 4 illustrates a framework-configuration user interface for constructing a configurable handwriting-recognition framework in accordance with one or more embodiments.

FIGS. 5A-5D illustrate example outputs of models of a configurable handwriting-recognition framework in accordance with one or more embodiments.

FIG. 6 illustrates a handwriting-recognition pipeline system training or otherwise fine-tuning a plurality of socket-specific models in accordance with one or more embodiments.

FIG. 7 illustrates a handwriting-recognition pipeline system determining a confidence score and an accuracy score for a particular combination of models of a configurable handwriting-recognition framework in accordance with one or more embodiments

FIG. 8 illustrates a genealogical-data system utilized by the handwriting-recognition pipeline system in accordance with one or more embodiments.

FIG. 9 illustrates an example series of acts for generating a genealogical record using a configurable handwriting-recognition framework in accordance with one or more embodiments.

FIG. 10 illustrates an exemplary computing system in accordance with one or more embodiments.

FIG. 11 illustrates an exemplary computing environment in accordance with one or more embodiments.

### DETAILED DESCRIPTION

This disclosure describes one or more embodiments of a handwriting-recognition pipeline system that can utilize a configurable handwriting-recognition framework to generate a genealogical record from a handwriting image. In practical scenarios, the handwriting-recognition pipeline system can enhance genealogical research (and/or genealogical database construction) by providing a plug-and-play platform (e.g., for generating or constructing a model pipeline in the form of a configurable handwriting-recognition framework), along with candidate models pluggable into respective model sockets of the platform, to generate a genealogical record from a handwriting image. Thus, for each use case, the handwriting-recognition pipeline system can customize the configurable handwriting-recognition framework by selecting and inserting a plurality of socket-specific models into a plurality of model sockets of the configurable handwriting-recognition framework. Specifically, the handwriting-recognition pipeline system can select each of the plurality of socket-specific models according to specific functions associated with the respective model sockets.

For example, the handwriting-recognition pipeline system can provide a platform or framework (e.g., the configurable handwriting-recognition framework) that includes pluggable model sockets that vary in number and/or compatibility with various model types. Through the configurable handwriting-recognition framework, the handwriting-recognition pipeline system can thus facilitate constructing or generating custom pipelines for extracting handwriting content and generating storable genealogical-content items for downstream use. For instance, the configurable handwriting-recognition framework can include a model socket associated with image transcription, a model socket associated with entity-extraction, and a model socket associated with relationship-extraction (along with other model sockets for other model types). The handwriting-recognition pipeline system further provides options for adding and/or removing various model sockets to further customize the configurable handwriting-recognition framework for specific use cases.

To facilitate the plug-and-play function of the configurable handwriting-recognition framework, the handwriting-recognition pipeline system can generate and provide a framework-configuration interface that includes a visualization of a pipeline framework currently being created, along with framework model sockets and tools for adding, removing, and modifying models in the model sockets. As part of the configuration options, the handwriting-recognition pipeline system can provide sets of candidate models for selection. For instance, the handwriting-recognition pipeline system can provide candidate models specific to each model socket type of the configurable handwriting-recognition framework, such as a set of candidate image-classification models, a set of candidate image-transcription models, a set of candidate entity-extraction models, and a set of candidate relationship-extraction models. The handwriting-recognition pipeline system thus facilitates customization of the configurable handwriting-recognition framework with user-selected models (and/or recommended or automatically selected models) in various model sockets.

Upon integrating an image-classification model in an image-classification model socket of the configurable handwriting-recognition framework, the handwriting-recognition pipeline system can analyze an input digital image to classify the image as a handwriting image. In addition, the handwriting-recognition system can integrate an image-transcription model into an image-transcription model socket to transcribe handwriting content from the handwriting image. Further, the configurable handwriting-recognition framework can integrate an entity-extraction model into an entity-extraction model socket and can still further integrate a relationship-extraction model into a relationship-extraction model socket of the configurable handwriting-recognition framework.

In some embodiments, the handwriting-recognition pipeline system can analyze the handwriting image to determine and recommend model socket-specific models to integrate into respective model sockets of the configurable handwriting-recognition framework. For instance, the handwriting-recognition pipeline system can utilize an image-classification model to classify and label the image with a particular record classification (e.g., a particular label or type of genealogical record). For instance, the handwriting-recognition pipeline system can use the record classification to indicate one or more aspects of the image, such as a corresponding region classification of the image, a corresponding content-item type of the image, a corresponding language of the image, among others. Upon classification, the handwriting-recognition pipeline system can further determine one or more additional models to suggest or recommend for adding to the configurable handwriting-recognition framework. In some cases, the handwriting-recognition pipeline system can generate or provide model socket-specific recommendations (e.g., a first recommendation for a layout-extraction model socket and a second recommendation for an entity-extraction model, and so forth) based on the type of genealogical record indicated by the image classification

Additionally, the handwriting-recognition pipeline system can configure the configurable handwriting-recognition framework such that model socket-specific models generate outputs that are compatible with downstream model sockets in the configurable handwriting-recognition framework. Indeed, as part of using a configurable handwriting-recognition framework to create a pipeline of models to extract handwriting content from an input digital image, the handwriting-recognition pipeline system can utilize a model-socket adapter. To elaborate, the handwriting-recognition pipeline system can use the model-socket adapter to render the output of a model integrated in a first model socket compatible as input into a model integrated in a second model socket. In some cases, the model-socket adapter adapts input and/or output data of a model to a universal model format applicable across all model sockets and/or models of the configurable handwriting-recognition framework.

Additionally, in some embodiments, the handwriting-recognition pipeline system can include an auditing function. The handwriting-recognition pipeline system can use the auditing function to evaluate performance of a specific embodiment of the configurable handwriting-recognition framework. For example, the handwriting-recognition pipeline system can generate the specific embodiment by inserting a specific combination of model socket-specific models into corresponding model sockets of the configurable handwriting-recognition framework. The handwriting-recognition pipeline system can use the specific embodiment to generate one or more genealogical records based on corresponding input digital images. Based on generating the one or more genealogical records, the handwriting-recognition pipeline system can use the auditing function to determine an accuracy score and/or a confidence score for the genealogical records that reflects a performance of the specific embodiment of the configurable handwriting-recognition framework. Responsive to determining the confidence score and/or the accuracy score, the handwriting-recognition pipeline system can determine to modify the specific embodiment of the handwriting-recognition pipeline system (e.g., such as by removing a first model from a first model socket of the configurable handwriting-recognition framework and inserting a different model into the first model socket).

As suggested above, the handwriting-recognition pipeline system provides several improvements over conventional systems. For example, the handwriting-recognition pipeline system can improve operational flexibility over prior systems. Through its configurable handwriting-recognition framework, the handwriting-recognition pipeline system flexibly selects and integrates model socket-specific models corresponding to model sockets of the configurable handwriting-recognition framework to create genealogical records from corresponding handwriting images. Thus, rather than generating handwriting-recognition pipelines in a piecewise manner on a case-by-case basis, the handwriting-recognition pipeline system can utilize a configurable handwriting-recognition framework to implement a uniform workflow process for handwriting recognition and selects model socket-specific models to insert into model sockets of the configurable handwriting-recognition framework according to the handwriting image. Indeed, the handwriting-recognition pipeline system can utilize the configurable handwriting-recognition framework to account for the disparity of different features in handwriting images, such as layout differences, linguistic differences, or regional differences, among others. The handwriting-recognition pipeline system thus improves operational flexibility over prior systems by utilizing the configurable handwriting-recognition framework to flexibly create a pluggable configurable handwriting-recognition framework, thus enabling uniform workflows that are adaptable to account for unique use cases.

Due at least in part to improving flexibility, the handwriting-recognition pipeline system also increases accuracy over prior systems. By utilizing the configurable handwriting-recognition framework to provide a uniform workflow process, and adapting the configurable handwriting-recognition framework by inserting model socket-specific models into model sockets of the configurable handwriting-recognition framework to account for unique use cases, the handwriting-recognition pipeline system can provide a combination of models according to specific aspects of the handwriting image (e.g., such as formatting type, document type, language type, etc.). Accordingly, the handwriting-recognition pipeline system can iteratively configure the configurable handwriting-recognition framework to accurately perform text extraction across a wide variety of input parameters (e.g., such as handwriting images depicting worn-out documents, linguistic changes, among others).

Further, the handwriting-recognition pipeline system improves computational efficiency over prior systems. By utilizing the configurable handwriting-recognition framework to generate customizable, adaptable handwriting-recognition pipelines, the handwriting-recognition pipeline system reduces computational resources (such as processing power, memory, and storage) used to train and implement handwriting-recognition pipelines in a case-by-case, piecewise manner. Indeed, through the configurable handwriting-recognition framework the handwriting-recognition pipeline system generates robust, flexible, accurate handwriting-recognition pipelines, thus reducing the amount of training required to generated new pipelines as well as further reducing the amount of tokenization performed compared to prior systems by reducing the need to repetitively generate different pipelines to analyze similar data sets.

As illustrated by the foregoing discussion, the present disclosure utilizes a variety of terms to describe features and benefits of the handwriting-recognition pipeline system. Additional detail is hereafter provided regarding the meaning of these terms as used in this disclosure. Further, while this disclosure focuses primarily on genealogical content in the context of a genealogical-data system, the handwriting-recognition pipeline system can perform one or more of the processes described herein in the context of other types of digital-content items and data systems as well.

As used herein, the term “textual content” refers to natural language content. The textual content can be handwritten, typed, and/or printed, among others. The textual content can be in a variety of different languages. Further, the textual content can be organized in various formats and/or layouts (such as paragraphs, tables, lists, descriptions of digital images, etc.).

As used herein, the term “handwriting image” can refer to a digital image that contains or depicts handwriting content. For example, a handwriting image can be a photocopy of a document that contains at least some handwriting, such as a digital image of a journal entry, a digital image of a letter or other handwritten correspondence, a digital image of a postcard, a digital image of official government documents (e.g., birth certificates, marriage certificates, death certificates, census records, passports and immigration forms, court records, property records, voting records, military service records), or other digital images that contain handwriting. In some embodiments, a handwriting image can be an as-yet unprocessed content item that the handwriting-recognition pipeline system 102 processes to generate a genealogical record.

As used herein, the term “configurable handwriting-recognition framework” refers to a customizable framework or platform for handwriting-recognition pipelines to generate genealogical records from handwriting images. For example, the configurable handwriting-recognition framework can include a plurality of adaptable, pluggable model sockets corresponding to different functions relating to handwriting-recognition. The configurable handwriting-recognition framework can further include model-socket adapters that connect the plurality of model sockets. Further, the handwriting-recognition pipeline system can determine a number of model sockets of the configurable handwriting-recognition framework according to a type of image the handwriting-recognition pipeline system uses the configurable handwriting-recognition framework to analyze or otherwise process handwriting images.

Moreover, as used herein, the term “image-classification model” can refer to a component of the configurable handwriting-recognition framework that processes digital images to classify them as handwriting images. For example, the handwriting-recognition pipeline system can use the image-classification model to perform image processing and feature-extraction techniques (e.g., such as edge detection, structural-feature extraction, line segmentation, aspect ratios, among others) on a digital image to determine that the digital image contains or otherwise depicts handwriting.

In addition, as used herein, the term “model socket” can refer to an element of the configurable handwriting-recognition framework that integrates a model socket-specific model into the configurable handwriting-recognition framework. A model socket can correspond to a specific functionality that the handwriting-recognition pipeline system uses the configurable handwriting-recognition framework to perform, such as layout-detection, transcription, entity-extraction, relationship-extraction, among others.

Further, as used herein, the term “model-socket adapter” can refer to a component of the configurable handwriting-recognition framework that connects two model sockets. For example, the handwriting-recognition pipeline system can insert a first model into a first model socket and a second model into a second model socket. The handwriting-recognition pipeline system can connect the two model sockets using a model-socket adapter. Specifically, the handwriting-recognition pipeline system can provide an output of the first model to the model-socket adapter and use the model-socket adapter to convert or otherwise modify the output of the first model into an input for the second model, such as by converting a format of the output.

Specifically, the handwriting-recognition pipeline system can use the model-socket adapters to convert inputs and outputs of models that the handwriting-recognition pipeline system inserts into the configurable handwriting-recognition framework to have a universal model format that is applicable all model socket-specific models the handwriting-recognition pipeline system can select to generate the configurable handwriting-recognition framework. Indeed, the handwriting-recognition pipeline system can use the model-socket adapters to generate the universal model format by modifying parameters, structures, formats, and/or languages of an output of a first model to be compatible with input parameters, structures, formats, and/or languages of a second model that is downstream in the configurable handwriting-recognition framework from the first model.

Further, in some embodiments, the handwriting-recognition pipeline system can use the model-socket adapters to generate the universal model format by converting outputs of an upstream model (e.g., a model in the configurable handwriting-recognition framework that generates an output that the configurable handwriting-recognition framework uses as an input into a subsequent model in the configurable handwriting-recognition framework) into an intermediary format. For example, the handwriting-recognition pipeline system can use a model-socket adapter to convert an output of an upstream model (e.g., a first model) into a predetermined universal model format by modifying parameters, format, structure, and/or a language of the output of the first model. The handwriting-recognition pipeline system can then convert the output of the first model from the universal model format output into input formatting requirements for a downstream model (e.g., a second model) by further modifying the parameters, format, structure, and/or language according to one or more requirements of the downstream model. The handwriting-recognition pipeline system can thus use the model-socket adapters to ensure uniform outputs and inputs of the configurable handwriting-recognition framework.

For example, the universal model format can be configured to account for generalities observed or determined between model types or model sockets, with pertinent schemas for model inputs and model outputs defined in response thereto. For instance, a layout-detection model and corresponding model socket can generally be expected to receive, as input, an image, and to output bounding-box proposals, confidence scores, and optionally associated labels, whereas a transcription model and corresponding model socket can generally be expected to receive, as input, the image, the bounding-box proposals, confidence scores, and where applicable the associated labels, and to output raw text associated with particular bounding-box coordinates, confidence scores, and where applicable associated labels.

The universal model format can advantageously be specific to particular implementations. For example, a handwriting-recognition universal model format can be associated with a plurality of model sockets associated with handwriting recognition tasks, whereas other tasks such as DNA-specific implementations can be associated with other universal model formats as suitable. When, in embodiments, an arrangement of model sockets is adjusted or specially configured for a particular use case, the universal model format can be correspondingly adjusted or specially configured.

Moreover, as used herein, the term “genealogical record” can refer to a digital object or a digital file that includes information (e.g., genealogical information) interpretable by a computing device (e.g., a client device) to present information to a user. The genealogical record can be an output of the configurable handwriting-recognition framework. The genealogical record can include a file such as a digital text file, a digital image file, a digital video file, a web file, a digital document file, or some other type of digital object. A genealogical record can contain information that indicates a genealogical relationship between user accounts.

As used herein, the term “content item” can refer to a digital object or a digital file that includes information (e.g., genealogical information) interpretable by a computing device to present information to a user. A content item can include a file such as a digital text file, a digital image file (e.g., a digital image of content item depicting handwriting content), a digital audio file, a webpage, a website, a digital video file, a web file, a link, a digital document file, or some other type of file or digital object. A content item can have a particular file type or file format, which may differ for different types of digital content items (e.g., digital documents, digital images, digital videos, or digital audio files). In some cases, a content item can refer to a genealogical record that includes or depicts historical or genealogical information, such as a birth certificate, a digitized newspaper article, a digitized photograph of a relative, a digitized census record, a digitized obituary, a digitized court document, or a digitized family tree. In some embodiments, a genealogical record includes a content item selected or identified to surface to a client device, such as an item in a response, a record hint (e.g., a stored or generated genealogical record surfaced as a suggestion for a user account), a digital story (e.g., a stored collection of genealogical records arranged for a particular person, topic, or entity of a genealogical-data system), a digital image (e.g., a digitized photograph), a new person hint (e.g., a suggested node to add to a genealogical tree), a member tree hint (e.g., a prediction for correcting a node within a genealogical tree of a user account), or a DNA match (e.g., a record indicating a DNA match of a user account to a relative whose information is stored in a genealogical-data system).

In addition, as used herein, the term “machine learning model” (or sometimes simply “model”) refers to a computer algorithm or a collection of computer algorithms that automatically improve for a particular task through iterative outputs or predictions based on use of data. For example, machine learning model can utilize one or more learning techniques to improve in accuracy and/or effectiveness. Example machine learning models include various types of neural networks, decision trees, support vector machines, and Bayesian networks. In some embodiments, the handwriting-recognition pipeline system utilizes a machine learning model in the form of a neural network.

Relatedly, as used herein, the term “neural network” refers to a machine learning model that can be trained and/or tuned based on inputs to determine classifications, scores, or approximate unknown functions. For example, a neural network includes a model of interconnected artificial neurons (e.g., organized in layers) that communicate and learn to approximate complex functions and generate outputs (e.g., handwriting content, data for passing to downstream models, and/or content items) based on a plurality of inputs provided to the neural network. In some cases, a neural network refers to an algorithm (or set of algorithms) that implements deep learning techniques to model high-level abstractions in data. A neural network can include various layers such as an input layer, one or more hidden layers, and an output layer that each perform tasks for processing data. For example, a neural network can include a deep neural network, a convolutional neural network, a recurrent neural network (e.g., an LSTM), a graph neural network, a transformer neural network, or a generative adversarial neural network. Upon training as described below, such a neural network may become a large language model that generates responses to prompts by interpreting prompt language, accessing additional data from content items, and executing functions indicated by prompts and/or content items.

Further, as used herein, the term “large language model” refers to a machine learning model trained to perform computer tasks to generate or identify content items in response to trigger events (e.g., user interactions, such as text queries, button selections, or uploading a digital image). In particular, a large language model can be a neural network (e.g., a deep neural network) with many parameters trained on large quantities of data (e.g., unlabeled text) using a particular learning technique (e.g., self-supervised learning). For example, a large language model can include parameters trained to generate model outputs (e.g., content items, summaries, or query responses) and/or to identify content items based on various contextual data, including graph information from a knowledge graph and/or historical user account behavior. In some cases, a large language model comprises a LLaMA model or a GPT model such as, but not limited to, ChatGPT.

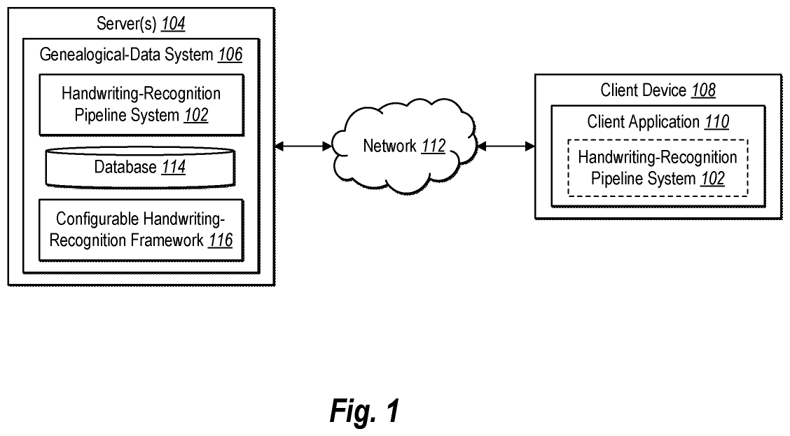

Additional detail regarding the handwriting-recognition pipeline system will now be provided with reference to the figures. For example, FIG. 1 illustrates a schematic diagram of an example system environment for implementing a handwriting-recognition pipeline system 102 in accordance with one or more implementations. An overview of the handwriting-recognition pipeline system 102 is described in relation to FIG. 1. Thereafter, a more detailed description of the components and processes of the handwriting-recognition pipeline system 102 is provided in relation to the subsequent figures.

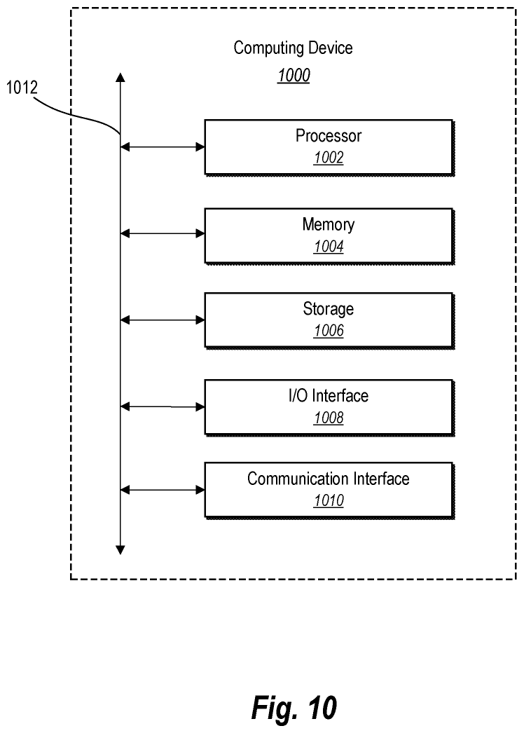

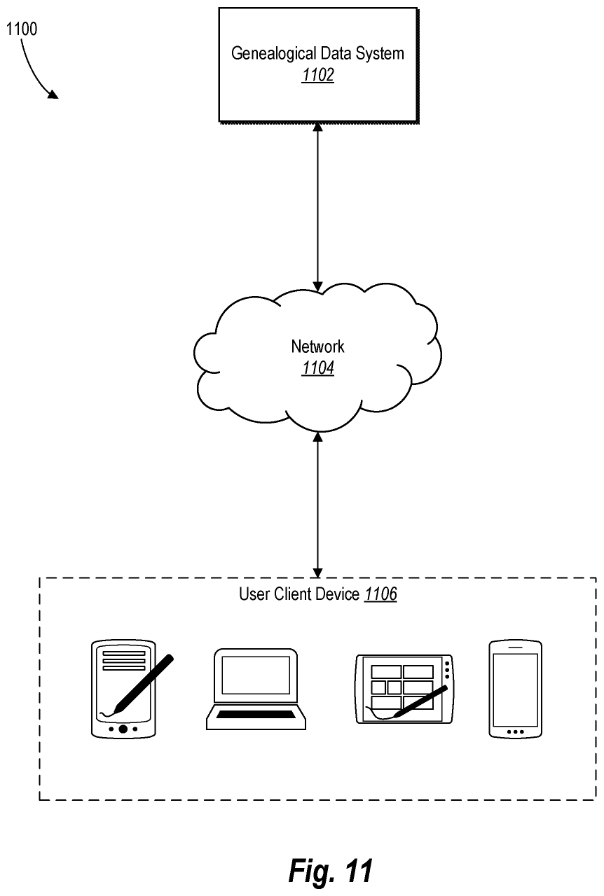

As shown, the environment includes server(s) 104, a client device 108, and a network 112. Each of the components of the environment can communicate via the network 112, and the network 112 may be any suitable network over which computing devices can communicate. Example networks are discussed in more detail below in relation to FIGS. 10-11.

As mentioned above, the example environment includes a client device 108. The client device 108 can be one of a variety of computing devices, including a smartphone, a tablet, a smart television, a desktop computer, a laptop computer, a virtual reality device, an augmented reality device, or another computing device as described in relation to FIGS. 10-11. The client device 108 can communicate with the server(s) 104 and/or the database 114 via the network 112. For example, the client device 108 can receive user input from respective users interacting with the client device 108 (e.g., via the client application 110) to, for instance, provide a user query as part of a genealogical research workflow and/or to search for, access, generate, modify, or share a genealogical record and/or to interact with a genealogy tree or a content item via a graphical user interface of the genealogical-data system 106. In addition, the handwriting-recognition pipeline system 102 on the server(s) 104 can receive information, such as a digital image, a query relating to various searches for, or interactions with, genealogical records, and/or user-interface elements based on the input received by the client device 108. The handwriting-recognition pipeline system 102 on the server(s) 104 can further use the configurable handwriting-recognition framework 116 to orchestrate generation of a genealogical record from a digital image.

As shown, the client device 108 can include a client application 110. In particular, the client application 110 may be a web application, a native application installed on the client device 108 (e.g., a mobile application, a desktop application, etc.), or a cloud-based application where all or part of the functionality is performed by the server(s) 104. Based on instructions from the client application 110, the client device 108 can present or display information, including a user interface such as a framework-configuration interface or some other graphical user interface, as described herein.

As illustrated in FIG. 1, the example environment also includes the server(s) 104. The server(s) 104 may generate, track, store, process, receive, and transmit electronic data, such as digital images, recommended model socket-specific models, genealogical records, prompts, generated responses, and/or interactions with content items. For example, the server(s) 104 may receive data from the client device 108 in the form of a digital image or a query relating to a digital image. In addition, the server(s) 104 can transmit data to the client device 108 in the form of a genealogical record using a configurable handwriting-recognition framework and can further modify a genealogical database according to the genealogical record. Indeed, the server(s) 104 can communicate with the client device 108 to send and/or receive data via the network 112. In some implementations, the server(s) 104 comprise(s) a distributed server where the server(s) 104 include(s) a number of server devices distributed across the network 112 and located in different physical locations. The server(s) 104 can comprise one or more content servers, application servers, communication servers, web-hosting servers, machine learning server, and other types of servers.

As shown in FIG. 1, the server(s) 104 can also include the handwriting-recognition pipeline system 102 as part of a genealogical-data system 106. The genealogical-data system 106 can communicate with the client device 108 to perform various functions associated with the client application 110 such as managing user accounts, managing genealogical data, managing genealogy trees, managing genealogical records, and facilitating user interaction with, and sharing of, the genealogy trees and/or genealogical records. Indeed, the genealogical-data system 106 can include a network-based cloud storage system to manage, store, and maintain genealogical records and genealogy trees related data user accounts. For instance, the genealogical-data system 106 can utilize genealogical data across various content items and user accounts to generate and maintain a universal genealogy tree that reflects the relatedness or consanguinity between nodes corresponding to all user accounts and other individuals indicated by stored genealogical records. In some embodiments, the handwriting-recognition pipeline system 102 and/or the genealogical-data system 106 utilize the database 114 to store and access information such as candidate model socket-specific models, genealogical records, genealogy trees, user account data, and/or other information.

As further illustrated in FIG. 1, the genealogical-data system 106 includes a database 114 that stores genealogical records and/or other data. In particular, the handwriting-recognition pipeline system 102 stores the genealogical records and searches the genealogical records to generate responses in response to queries. For instance, the handwriting-recognition pipeline system 102 receives a query from the client device 108 and generates, a response that includes one or more records from among the genealogical records.

Although FIG. 1 depicts the handwriting-recognition pipeline system 102 located on the server(s) 104, in some implementations, the handwriting-recognition pipeline system 102 may be implemented by (e.g., located entirely or in part on) one or more other components of the environment. For example, the handwriting-recognition pipeline system 102 may be implemented in whole or in part by the client device 108. For example, the client device 108 and/or a third-party system can download all or part of the handwriting-recognition pipeline system 102 for implementation independent of, or together with, the server(s) 104.

In some implementations, though not illustrated in FIG. 1, the environment may have a different arrangement of components and/or may have a different number or set of components altogether. For example, the client device 108 may communicate directly with the handwriting-recognition pipeline system 102, bypassing the network 112. As another example, the environment may include multiple client devices, each associated with a different user account. In addition, the environment can include the database 114 located external to the server(s) 104 (e.g., in communication via the network 112) or located on the server(s) 104 and/or on the client device 108.

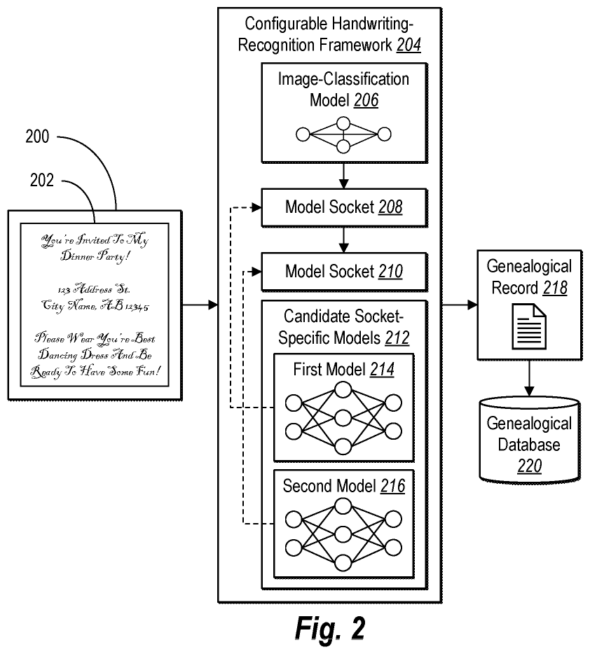

As mentioned above, the handwriting-recognition pipeline system 102 can utilize a configurable handwriting-recognition framework to generate a genealogical record from a handwriting image. FIG. 2 illustrates the handwriting-recognition pipeline system 102 utilizing a configurable handwriting-recognition framework including a plurality of model sockets corresponding to candidate model socket-specific models, which, in some embodiments, are model socket-specific large language models, to generate a genealogical record from a handwriting image and utilize the generated genealogical record to modify a genealogical database in accordance with one or more embodiments. Additional detail regarding the various acts and processes introduced in relation to FIG. 2 is provided thereafter with reference to subsequent figures.

As shown in FIG. 2, the handwriting-recognition pipeline system 102 can receive a digital image 200. The handwriting-recognition pipeline system 102 can use an image-classification model 206 of a configurable handwriting-recognition framework 204 to classify the digital image 200 as a handwriting image (based on its depiction of textual content, such as handwriting content 202). For example, the handwriting-recognition pipeline system 102 can generate a framework-configuration user interface on a client device. Within the framework-configuration user interface, the handwriting-recognition pipeline system 102 can generate and provide a selection of model elements corresponding to candidate model socket-specific models for insertion of model-socket elements corresponding to model sockets of the configurable handwriting-recognition framework 204. Specifically, the handwriting-recognition pipeline system 102 can generate the selection of model elements and model-socket elements to enable a user account to interact with the framework-configuration user interface by iteratively clicking, dragging, or otherwise interacting with a model element to insert the model element into a corresponding model-socket element to create the configurable handwriting-recognition framework 204.

Based on determining that the digital image 200 depicts the handwriting content 202, the handwriting-recognition pipeline system 102 can modify the configurable handwriting-recognition framework 204 by identifying model socket-specific models from a plurality of candidate model socket-specific models 212. The handwriting-recognition pipeline system 102 can further insert the model socket-specific models into corresponding model sockets of a plurality of model sockets of the configurable handwriting-recognition framework 204 according to one or more aspects of the handwriting content 202.

As shown in FIG. 2, the handwriting-recognition pipeline system 102 can integrate a first model 214 of the plurality of candidate model socket-specific models 212 into a model socket 208 of the configurable handwriting-recognition framework 204. In some embodiments, the model socket 208 and the first model 214 can correspond to a first function of the configurable handwriting-recognition framework 204, such as layout-detection. The handwriting-recognition pipeline system 102 can select the first model 214 from among a subset of the plurality of socket-specific models that correspond to the first function.

As illustrated in FIG. 2, the handwriting-recognition pipeline system 102 can insert a second model 216 into a model socket 210 of the configurable handwriting-recognition framework 204. The second model 216 and the model socket 210 can correspond to a second function of the configurable handwriting-recognition framework 204 to perform. For example, the handwriting-recognition pipeline system 102 can insert the second model 216 into the model socket 210 to transcribe handwriting content corresponding to or contained within the plurality of sections that the handwriting-recognition pipeline system 102 used the first model 214 to identify.

For example, the handwriting-recognition pipeline system 102 can use the image-classification model 206 to identify a plurality of aspects of the handwriting content 202, such as a layout format and a language. The handwriting-recognition pipeline system 102 can select a layout-detection model from a plurality of layout-detection models as the first model 214 for insertion into the model socket 208. The handwriting-recognition pipeline system 102 can use the layout-detection model to identify and/or separate different portions of the handwriting content 202 of the digital image 200. The handwriting-recognition pipeline system 102 can further configure the layout-detection model to perform region segmentation—that is, to further perform segmentation on identified regions from a first pass of the model, and, in embodiments, to combine distinct segments into consolidated regions based on, e.g., topical continuity. The handwriting-recognition pipeline system 102 can use the layout-detection model to identify a plurality of classes of segments, such as tables, lists, pedigrees, free-form text, margin notes, headers, images, etc. Additionally, the handwriting-recognition pipeline system 102 can select a transcription model from a plurality of transcription models for insertion into the model socket 210. The handwriting-recognition pipeline system 102 determine the transcription model according to a language and/or other feature of the handwriting content 202, such as whether the handwriting content 202 includes machine-printed or -generated, typewritten, handwritten, or other types of text, and can use the transcription model to transcribe portions of the digital image 200 that the handwriting-recognition pipeline system 102 uses the layout-detection model to generate. The handwriting-recognition pipeline system 102 can configure the transcription model to attach the generated transcriptions to the corresponding regions by generating and/or attaching pertinent metadata thereto and/or by grouping the generated transcription data to corresponding region and/or image data as suitable.

In some embodiments, the handwriting-recognition pipeline system 102 can determine to modify the configurable handwriting-recognition framework 204 by adding or removing model sockets and inserting candidate model socket-specific models into the model sockets. To illustrate, in some embodiments the handwriting-recognition pipeline system 102 can add a third model socket to the configurable handwriting-recognition framework 204 and insert an entity-extraction model from a plurality of entity-extraction models into the third model socket. The handwriting-recognition pipeline system 102 can use the entity-extraction model to identify entities (e.g., specific terms or phrases in a body of text that can be identified as a fact, keyword, or otherwise containing meaningful information, such as people, places, dates, events, and/or objects) in the transcriptions that the handwriting-recognition pipeline system 102 uses the transcription model to generate. The handwriting-recognition pipeline system 102 can configure the entity-extraction model to receive the upstream-generated transcriptions and/or associated regions and/or images and to generate entity labels to attach to or otherwise associate with the transcriptions. Further, the handwriting-recognition pipeline system 102 can add a fourth model socket to the configurable handwriting-recognition framework 204 and insert a relationship-extraction model from a plurality of relationship-extraction models into the fourth model socket. The handwriting-recognition pipeline system 102 can use the relationship-extraction model to identify relationships between the entities from the entity-extraction model. The relationship-extraction model may be configured to receive the upstream-generated transcriptions and entity labels and/or associated regions and/or images and to generate relationship labels for or between entity labels and associated transcription components. The handwriting-recognition pipeline system 102 can use the relationship-extraction model to identify relationships, such as a relationship between two specific entities to connect the entities in the overall context of the genealogical record. Relationship types may include family relationships, person-event data, event data, and/or person data. The handwriting-recognition pipeline system 102 uses the identified relationships to structure the entities and further uses the transcription and provide additional meaning or context. In some embodiments, the handwriting-recognition pipeline system 102 can structure the configurable handwriting-recognition framework 204 to implement the entity-extraction model and the relationship-extraction model in parallel.

In some embodiments, the handwriting-recognition pipeline system 102 can add a fifth model socket to the configurable handwriting-recognition framework 204 and insert a componentization model from a plurality of componentization models into the fifth model socket. The handwriting-recognition pipeline system 102 can use the componentization model to discretize extracted entities and/or relationships into component or constituent parts. For example the componentization model can be utilized by the handwriting-recognition pipeline system 102 to discretize an extracted “full name” entity into, e.g., given name, middle name, maiden name, and/or surname components. Dates may similarly be broken down in components, as many locations. Other possibilities are contemplated. As suitable the componentization model may be utilized upstream of the relationship-extraction model.

Based on selecting and inserting the first model 214 into the model socket 208 and the second model 216 into the model socket 210, the handwriting-recognition pipeline system 102 can use the configurable handwriting-recognition framework 204 to generate a genealogical record 218 from the handwriting content 202. For example, the handwriting-recognition pipeline system 102 can generate the genealogical record 218 to include one or more representations of the sections that the handwriting-recognition pipeline system 102 identifies with the layout-detection model, the transcriptions that the handwriting-recognition pipeline system 102 generates with the transcription model, the entities that the handwriting-recognition pipeline system 102 extracts with the entity-extraction model, and/or the relationships that the handwriting-recognition pipeline system 102 extracts with the relationship-extraction model.

In embodiments, the handwriting-recognition pipeline system 102 can utilize a post-processing component or process to generate the genealogical record 218 from the handwriting content 202 and using the outputs of the upstream models. For example, the post-processing component may be a model the handwriting-recognition pipeline system 102 configures to receive the upstream-model outputs and to consolidate pertinent outputs into a genealogical record comprising or defining a digital file comprising structured genealogical data. For instance, the upstream configurable handwriting-recognition framework comprising model sockets and corresponding models for layout-detection, transcription, entity-extraction, and relationship-extraction may generate image segments and classifications along with associated transcriptions and entity and relationship labels.

The handwriting-recognition pipeline system 102 can configure the post-processing component to use to structure these inputs into a digital file that the handwriting-recognition pipeline system 102 can publish to a genealogical research service, such that as a user views the original image, the handwriting-recognition pipeline system 102 can present the user with the transcriptions, entities, and relationships associated with one or more segments of the original image. Further, handwriting-recognition pipeline system 102 can generate the transcriptions, entities, and relationships to be searchable and retrievable by a genealogical database. Further, the handwriting-recognition pipeline system 102 can configure the post-processing component to consolidate genealogical data, such as handwriting content, from a plurality of images as suitable. For instance, some tables, pedigrees, free-form text, etc. may span a plurality of pages of an imported record book. The handwriting-recognition pipeline system 102 can train the post-processing component to consolidate and/or extent transcriptions, entities, and relationships as suitable to ensure continuity between pages.

In embodiments, the post-processing component may be a record-converter application that the handwriting-recognition pipeline system 102 configures to receive the upstream-generated data (e.g. the layout-extraction predictions, transcriptions, and associated entities and relationships) from, in embodiments, a centralized prediction storage in which the handwriting-recognition pipeline system 102 can store aforementioned intermediate results, as a prediction set, and to apply, in embodiments, a project-specific configuration thereto to construct the genealogical records. That is, in embodiments, the handwriting-recognition pipeline system 102 can prompt a user may to select, modify, and/or supply a project-specific configuration associated with the pertinent use case.

In embodiments, the handwriting-recognition pipeline system 102 can configure the record-converter application to generate partial genealogical records in response to the upstream-generated data, for instance to generate a genealogical record specific to each entity corresponding to an individual person identified from a particular input image. The handwriting-recognition pipeline system 102 can generate such partial genealogical records first and then collate or combine them in order to generate a full genealogical record comprising all of the person-specific entities identified in the input image. The handwriting-recognition pipeline system 102 can additionally or alternatively use the record-converter application to confirm or configure the project-specific configuration for the genealogical record to be an indexing record format, with the entities, relationships, and other upstream-generated data arranged, as suitable, into fields of the project-specific configuration, including levels that include images, headers, and records. The image level may comprise information extracted about the image, including image-identification metadata, image-classification metadata, etc. The header level may comprise information from a variable list of fields, including fields shared across multiple records. The record level may comprise information from a variable list of fields, including record-identification metadata, image-location metadata, entity-identification metadata, and others.

In embodiments, the handwriting-recognition pipeline system 102 can configure the record-converter application to extract labels representing data about entities and relationships from particular regions of an image and to extract labels about entities and relationships from a generated graph of entities connected by relationships produced by the entity-extraction and/or relationship-detection models. These handwriting-recognition pipeline system 102 can then structure the extracted labels according to, e.g., the aforementioned levels.

In some embodiments, the handwriting-recognition pipeline system 102 can generate a candidate model socket-specific model of the plurality of candidate model socket-specific models 212 to be a model socket-specific large language model. For example, the handwriting-recognition pipeline system 102 can train or otherwise fine-tune a large language model according to a function of a model socket (e.g., such as the model socket 208). For example, the handwriting-recognition pipeline system 102 can fine-tune the model socket-specific large language model using model socket-specific examples (e.g., such as layout-specific examples, transcription-specific examples, entity-extraction-specific examples, relationship-extraction-specific examples). In some embodiments, the handwriting-recognition pipeline system 102 can implement an automated training process to train the plurality of candidate model socket-specific models 212.

In embodiments, the handwriting-recognition pipeline system 102 can implement an automated training process that utilizes a training-data database. The training-data database may store training data for a plurality of use cases germane to the handwriting-recognition pipeline system 102. For example, training data stored in the training-data database may include labeled layout-detection training samples, labeled entity-extraction training samples, labeled transcription training samples, labeled relationship-detection training samples, labeled componentization training samples, and/or any other suitable type of training sample. In embodiments, the training-data database automatedly discretizes sets of training data into test, training, and validation subsets.

The training database may comprise, as suitable, at least a predefined minimum number of training samples for each of a plurality of predefined use cases. For example, for a handwriting-recognition use case comprising discrete steps for layout-detection, handwriting transcription, entity-extraction, and separate relationship-extraction, a minimum volume of training-data samples may be stored for fine-tuning models for each of the discrete steps. The minimum volume includes a minimum of 100 images for each discrete step, in some embodiments a minimum of 1,000 images for each discrete step, in some embodiments a minimum of 10,000 images for each discrete step, and so on.

Further, the handwriting-recognition pipeline system 102 can use the genealogical record 218 to update or otherwise modify a genealogical database 220. For example, the handwriting-recognition pipeline system 102 can modify the genealogical database 220 by updating a node of the genealogical database to reflect a relationship described or otherwise depicted in the genealogical record 218. For example, responsive to generating the genealogical record 218, the handwriting-recognition pipeline system 102 can modify one or more clusters of a cluster database to reflect information, such as genealogical relationships, identified in the genealogical record 218. Additionally or alternatively, the handwriting-recognition pipeline system 102 can use the genealogical record 218 to modify nodes and edges of a tree database for one or more genealogical trees to reflect information, such as genealogical relationships, identified in the genealogical record 218.

For example, based on generating the genealogical record 218, the handwriting-recognition pipeline system 102 can identify a genealogical relationship between a user corresponding to a user account and a deceased individual, such as a great-great-great aunt. The handwriting-recognition pipeline system 102 can use the information of the genealogical record 218 to update a genealogical tree of the user account (e.g., such as by adding a new node corresponding to the great-great-great aunt and an edge connecting the new node to another node in the genealogical tree, such as the user's great-great-grandparents). Based on updating the genealogical tree, the handwriting-recognition pipeline system 102 can further modify a tree database to reflect the genealogical relationship (by similarly adding a node and edge).

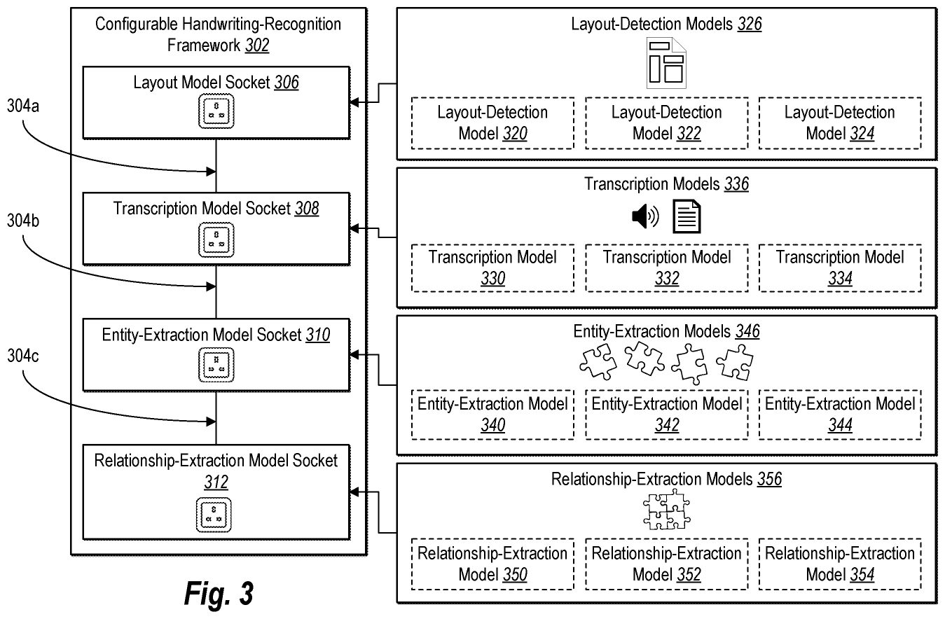

FIG. 3 illustrates the handwriting-recognition pipeline system 102 inserting models into model sockets of a configurable handwriting-recognition framework 302 in accordance with one or more embodiments. For example, the handwriting-recognition pipeline system 102 can generate the configurable handwriting-recognition framework 302 to include a layout model socket 306, a transcription model socket 308, an entity-extraction model socket 310, and a relationship-extraction model socket 312 (among others).

The handwriting-recognition pipeline system 102 can determine to insert a layout-detection model 320, a layout-detection model 322, or a layout-detection model 324 from a plurality of available layout-detection models 326 into the layout model socket 306. In some embodiments, the handwriting-recognition pipeline system 102 selects the layout-detection models to include in the plurality of available layout-detection models 326 based on metadata associated with each model. For example, the handwriting-recognition pipeline system 102 can maintain a layout-detection model repository that includes layout-detection models associated with a genealogical-data system (e.g., the genealogical-data system 106 discussed above with regard to FIG. 1). In some embodiments, the plurality of available layout-detection models 326 includes one or more of an image segmentation model, a region segmentation model, a region combination model, a region classification model, a table classification model, and/or a list classification model, among others. Further, in some embodiments the handwriting-recognition pipeline system 102 suggests (e.g., via a framework-configuration interface) and/or selects a layout-detection model from the plurality of available layout-detection models 326 to insert into the layout model socket 306.

As shown in FIG. 3, the handwriting-recognition pipeline system 102 can determine to insert a transcription model 330, a transcription model 332, or a transcription model 334 from a plurality of available transcription models 336 into the transcription model socket 308. In some embodiments, the handwriting-recognition pipeline system 102 selects transcription models to include in the plurality of available transcription models 336 according to metadata associated with each model. To illustrate, the handwriting-recognition pipeline system 102 can maintain a transcription model repository that includes layout-detection models associated with the genealogical-data system. Moreover, in some embodiments the plurality of available transcription models 336 can include optical character recognition models and/or vision-language models, among others. The handwriting-recognition pipeline system 102 can select transcription models to include in the plurality of available transcription models 336 to include transcription models that transcribe one or more styles of textual content. For example, the handwriting-recognition pipeline system 102 can select transcription models to utilize to transcribe handwriting (e.g., depicted in the textual content of the digital image, such as a handwriting image), transcription models that transcribe one or more styles of typographical text (e.g., depicted in the handwriting image), and transcription models that transcribe different languages (e.g., depicted in the handwriting image). Additionally, in some embodiments the handwriting-recognition pipeline system 102 suggests (such as via a framework-configuration interface) and/or selects a model from among the plurality of available transcription models 336 to insert into the transcription model socket 308.

As shown in FIG. 3, the handwriting-recognition pipeline system 102 can determine to insert an entity-extraction model 340, an entity-extraction model 342, or an entity-extraction model 344 from a plurality of available entity-extraction models 346 into the entity-extraction model socket 310. In some embodiments, the handwriting-recognition pipeline system 102 selects entity-extraction models to include in the plurality of available entity-extraction models 346 according to metadata associated with each model. To illustrate, the handwriting-recognition pipeline system 102 can maintain an entity-extraction model repository that includes entity-extraction models associated with the genealogical-data system. Indeed, the handwriting-recognition pipeline system 102 can generate the entity-extraction model repository to include entity indicators for each entity-extraction model in the entity-extraction model repository that indicates entity types that each entity-extraction model identifies (such as life events, ages, dates, surnames, given names, places, etc. ,). Further, the plurality of available entity-extraction models 346 can include natural language processing models, such as language-specific language processing models. Further, in some embodiments the handwriting-recognition pipeline system 102 suggests (via a framework-configuration interface) and/or selects an entity-extraction model from among the plurality of available entity-extraction models 346 to insert into the entity-extraction model socket 310.

As illustrated in FIG. 3, the handwriting-recognition pipeline system 102 can determine to insert a relationship-extraction model 350, a relationship-extraction model 352, or a relationship-extraction model 354 (of the same or different architectures) from a plurality of available relationship-extraction models 356 into the relationship-extraction model socket 312. To illustrate, the handwriting-recognition pipeline system 102 can select relationship-extraction models to include in the plurality of available relationship-extraction models 356 according to metadata associated with each model. For example, the handwriting-recognition pipeline system 102 can maintain a relationship-extraction model repository that includes relationship-extraction models associated with the genealogical-data system. Further, the handwriting-recognition pipeline system 102 can generate the relationship-extraction model repository to include relationship indicators for each relationship-extraction model in the relationship-extraction model repository that indicates relationship types that each relationship-extraction model identifies (such as familial relationships, genders of individuals, dates of events, locations of events, among others). Additionally, the handwriting-recognition pipeline system 102 can suggest (via a framework-configuration interface) and/or select a relationship-extraction model from among the plurality of available entity-extraction models to insert into the relationship-extraction model socket 312.

As shown in FIG. 3, the handwriting-recognition pipeline system 102 can use a plurality of model-socket adapters 304a, 304b, and 304c to connect model sockets of the configurable handwriting-recognition framework 302 to standardize outputs and inputs of models the handwriting-recognition pipeline system 102 inserts into the model sockets. For example, the handwriting-recognition pipeline system 102 can utilize the plurality of model-socket adapters 304a, 304b, and 304c to convert outputs of each component of the configurable handwriting-recognition framework 302 into a standardized data format and/or schema, such that the inputs and/or outputs of respective models or components are inter-compatible with one another. For example, the handwriting-recognition pipeline system 102 can utilize the plurality of model-socket adapters 304a, 304b, and 304c to standardize outputs from the layout-detection model (e.g., that corresponds to the layout model socket 306) such that, regardless of which layout-detection model of the plurality of available layout-detection models 326 the handwriting-recognition pipeline system 102 inserts into the configurable handwriting-recognition framework, the inputs and outputs of the models of the configurable handwriting-recognition framework 302 will be compatible with each other.

To illustrate, the handwriting-recognition pipeline system 102 generates a first model-socket adapter 304a to convert the outputs of any of the plurality of available layout-detection models 326 into a first standardized data format that is usable as an input for any of the plurality of available transcription models 336. Additionally, the handwriting-recognition pipeline system 102 generates a second model-socket adapter 304b to convert outputs of any of the plurality of available transcription models 336 into a second standardized data format that is usable as an input for any of the plurality of available entity-extraction models 346. Moreover, the handwriting-recognition pipeline system 102 generates a third model-socket adapter 304c to convert outputs of any of the plurality of available entity-extraction models 346 into a third standardized data format that is usable as an input for any of the plurality of available of relationship-extraction models 356.

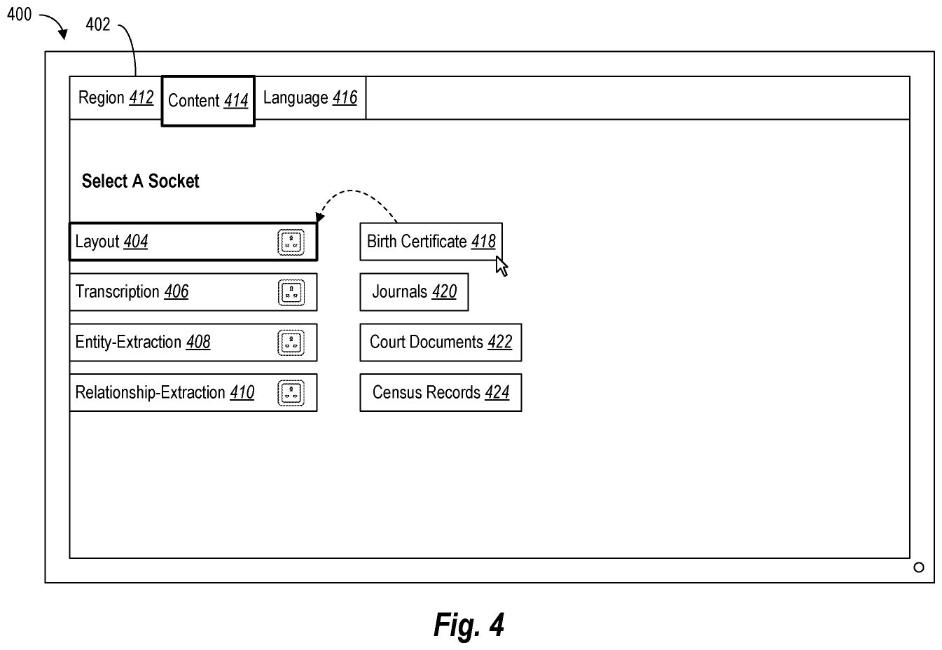

As shown in FIG. 4, the handwriting-recognition pipeline system 102 can generate and provide a framework-configuration interface 402 for display in a client device 400. The handwriting-recognition pipeline system 102 can generate the framework-configuration interface 402 to include a plurality of socket elements corresponding to model sockets of a configurable handwriting-recognition framework (e.g., a first model-socket element 404 corresponding to a layout model socket, a second model-socket element 406 corresponding to a transcription model socket, a third model-socket element 408 corresponding to an entity-extraction model socket, and a fourth model-socket element 410 corresponding to a relationship-extraction model socket).

Further, the handwriting-recognition pipeline system 102 can generate the framework-configuration interface 402 to include a plurality of model-type elements corresponding to types of models (e.g., a first model-type element 412 corresponding to region-specific models, a second model-type element 414 corresponding to content-specific models, and a third model-type element 416 corresponding to language-specific models). Each of the tabs for the model-type elements are selectable to present respective model types for inserting into model sockets. Region-specific models can include models trained on specific layouts, formats, or structures of genealogical-content items specific to geographic regions and/or geopolitical boundaries (e.g., where birth certificates of one country have a different layout and/or include different information compared to those of another country). Content-specific models can include models for various types or categories of genealogical-content items (e.g., birth certificates, journals, court documents, and census records as shown). Language-specific models include models trained on genealogical data in various languages.

In addition, the handwriting-recognition pipeline system 102 can generate the framework-configuration interface 402 to include a plurality of model elements corresponding to specific models for insertion into elements of the plurality of model-socket elements (e.g., a first model element 418 corresponding to a birth certificate model, a second model element 420 corresponding to a journal model, a third model element 422 corresponding to a court documents model, and a fourth model element 424 corresponding to a census records model).

Accordingly, the handwriting-recognition pipeline system 102 can construct a configurable handwriting-recognition framework based on determining a series of interactions within the framework-configuration interface 402. For example, based on determining an interaction with a model-type element of the model-type elements 412, 414, and/or 416, the handwriting-recognition pipeline system 102 can modify the framework-configuration interface 402 to display model elements that correspond to the selected model-type element. Further, the handwriting-recognition pipeline system 102 can insert a candidate socket-specific model into a corresponding socket of the configurable handwriting-recognition framework based on determining an indication of a socket-insertion interaction via the framework-configuration interface 402.

To illustrate, the handwriting-recognition pipeline system 102 can determine the socket-insertion interaction by identifying a drag-and-drop interaction between a model element and a socket element. Indeed, as shown in FIG. 4, the handwriting-recognition pipeline system 102 can identify the socket-insertion interaction by determining an indication of an insertion of the first model element 418 into the first model-socket element 404 (e.g., such as a user account dragging the first model element 418 into the first model-socket element 404). In some embodiments, the handwriting-recognition pipeline system 102 identifies the socket-insertion interaction by determining an interaction pair that includes a model-socket element interaction (e.g., such as a click or a tap of the first model-socket element 404, the second model-socket element 406, the third model-socket element 408, or the fourth model-socket element) and a model element interaction (e.g., such as a click or a tap of the first model element 418, the second model element 420, the third model element 422, or the fourth model element 424).

In some embodiments, the handwriting-recognition pipeline system 102 generates the framework-configuration interface 402 to display the model-socket elements 404, 406, 408, and 410 as tabs of the framework-configuration interface 402. Accordingly, the handwriting-recognition pipeline system 102 can utilize the framework-configuration interface 402 to display model elements and/or model-type elements according to corresponding model-socket elements. Moreover, the handwriting-recognition pipeline system 102 can configure displays of the framework-configuration interface 402 according to input from a user account. Furthermore, the handwriting-recognition pipeline system 102 can modify which model-socket elements the handwriting-recognition pipeline system 102 displays on the framework-configuration interface 402, such as by adding and/or removing model-socket elements to the framework-configuration interface 402.

Further, as previously discussed, in some embodiments the handwriting-recognition pipeline system 102 provides suggestions, via the framework-configuration interface 402, for which model element to insert into a corresponding model-socket element. For example, the handwriting-recognition pipeline system 102 can generate the framework-configuration interface to include a chat interface. The handwriting-recognition pipeline system 102 can receive, via the chat interface, natural language queries regarding constructing the configurable handwriting-recognition framework. Further, the handwriting-recognition pipeline system 102 can utilize a large language model to generate and provide responses the natural language queries and/or suggestions for modifying the configurable handwriting-recognition framework. For example, the handwriting-recognition pipeline system 102 can train the natural language model utilizing data and/or metadata of the layout-detection model repository, the transcription model repository, the entity-extraction model repository, and/or the relationship-extraction model repository, among others.

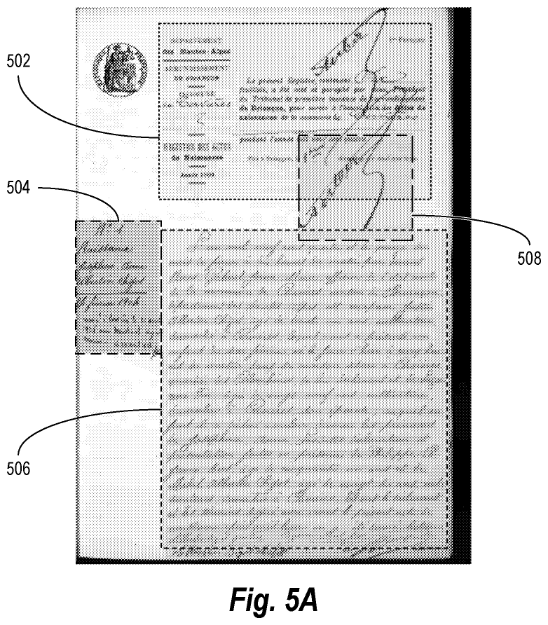

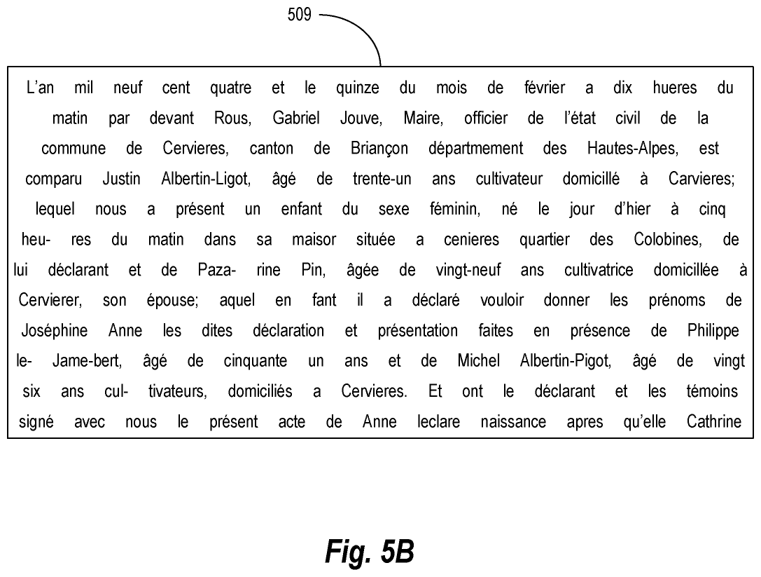

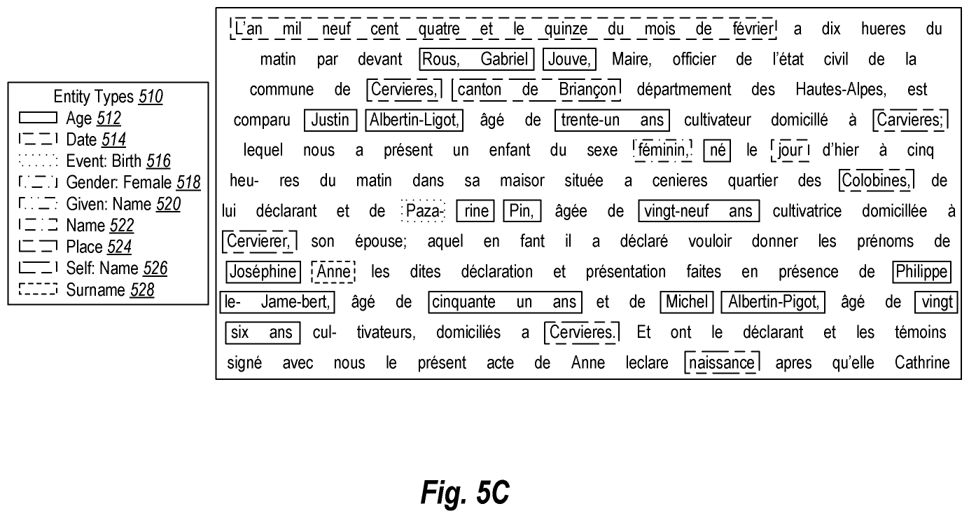

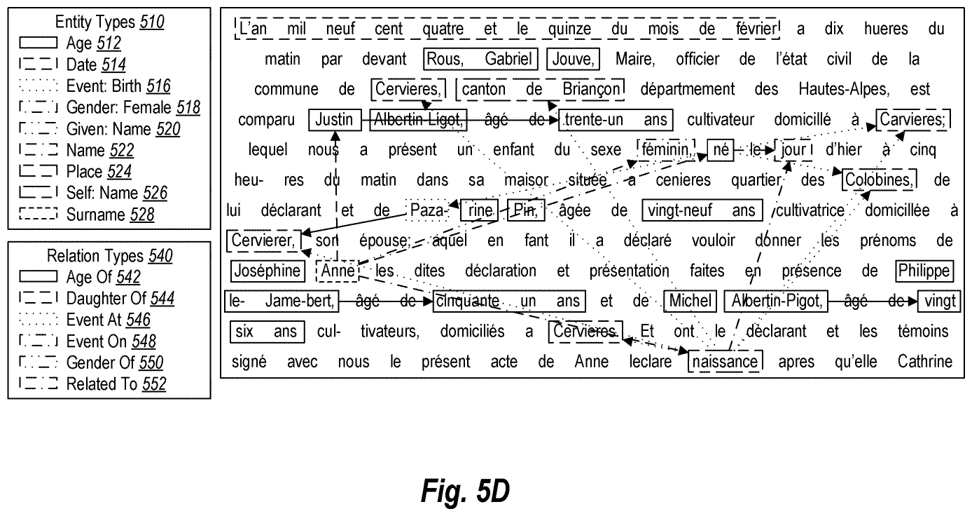

As shown in FIGS. 5A-5D, the handwriting-recognition pipeline system 102 can identify sections of handwriting content from a digital image (e.g., as shown in FIG. 5A). Based on identifying the sections of handwriting content, the handwriting-recognition pipeline system 102 can generate a transcription of a section of handwriting content (e.g., as shown in FIG. 5B). Based on generating the transcription, the handwriting-recognition pipeline system 102 can extract or otherwise identify entities within the transcription (e.g., as shown in FIG. 5C). Based on identifying the entities within the transcription, the handwriting-recognition pipeline system 102 can identify or otherwise extract relationships between the entities (e.g., as shown in FIG. 5D). Accordingly, the discussion of FIGS. 5A-5D thus illustrates outputs that correspond to sockets of a configurable handwriting-recognition framework (e.g., downstream sequential outputs). For example, the handwriting-recognition pipeline system 102 can insert a layout-detection model into a layout model socket to identify sections of handwriting content in a digital image. The handwriting-recognition pipeline system 102 can insert a transcription model into a transcription model socket to transcribe the sections. Further, the handwriting-recognition pipeline system 102 can insert an entity-extraction model into an entity-extraction model socket to identify entities from the transcription. Further, the handwriting-recognition pipeline system 102 can insert a relationship-extraction model into a relationship-extraction model socket to identify relationships between the entities.

Specifically, as shown in FIG. 5A, the handwriting-recognition pipeline system 102 can use a layout-detection model to detect a plurality of sections 502, 504, 506, and 508 in a handwriting image that depict textual content. For example, the handwriting-recognition pipeline system 102 can utilize the layout-detection model to segment the handwriting image to identify the plurality of sections 502, 504, 506, and 508. The handwriting-recognition pipeline system 102 can provide the plurality of sections 502, 504, 506, 508 to a transcription model (e.g., such as through model-socket adapters of a configurable handwriting-recognition framework).

As shown in FIG. 5B, the handwriting-recognition pipeline system 102 can use a transcription model to generate a transcription 509 from a section of the plurality of 502, 504, 506, 508 that the handwriting-recognition pipeline system 102 used the layout-detection model to extract. For example, the handwriting-recognition pipeline system 102 can utilize the transcription model, such as an optical character recognition model, to generate machine-readable text from the section of the plurality of sections 502, 504, 506, 508.

As shown in FIG. 5C, the handwriting-recognition pipeline system 102 can use an entity-extraction model to determine a plurality of entity types 510 (e.g., age 512, date 514, event: birth 516, gender: female 518, given: name 520, name 522, place 524, self: name 526, and surname 528) from a transcription (such as the transcription 509) that the handwriting-recognition pipeline system 102 used the transcription model to generate. For example, the handwriting-recognition pipeline system 102 can utilize the entity-extraction model to perform natural language processing on the transcription. Further, the handwriting-recognition pipeline system 102 can generate the configurable handwriting-recognition framework to include the entity-extraction model based on determining a language of text depicted in the handwriting image.

As shown in FIG. 5D, the handwriting-recognition pipeline system 102 can use a relationship-extraction model to determine a plurality of relation types 540 (e.g., age of 542, daughter of 544, event at 546, event on 548, gender of 550, related to 552) between the entities that the handwriting-recognition pipeline system 102 used the entity-extraction model to determine (such as the age 512, the date 514, the event: birth 516, the gender: female 518, the given: name 520, name 522, the place 524, the self: name 526, and the surname 528). In some embodiments, the handwriting-recognition pipeline system 102 can determine the plurality of relation types 540 in parallel with determining the plurality of entity types 510 (e.g., age 512, date 514, event: birth 516, gender: female 518, given: name 520, name 522, place 524, self: name 526, and surname 528). In some embodiments, the handwriting-recognition pipeline system 102 utilizes the relationship-extraction model to determine the plurality of relationship types among the entities by performing contextualized natural language processing on the entities.

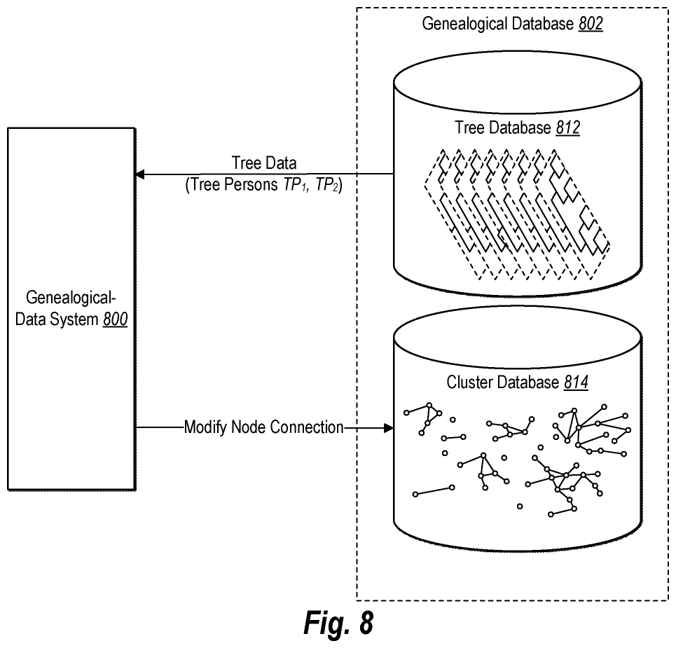

Further, based on extracting the entity types 510 and/or the relation types 540, the handwriting-recognition pipeline system 102 can generate a genealogical record that includes the entity types 510 and/or the relation types 540. In some embodiments, the handwriting-recognition pipeline system 102 provides the genealogical record for display within a user interface of a client device (such as within a framework-configuration interface or another user interface of a genealogical-data system). Further, based on identifying the entity types 510 and/or the relation types 540, the handwriting-recognition pipeline system 102 can modify one or more genealogical databases of the genealogical-data system, such as a tree database 812 and/or a cluster database 814 of FIG. 8 discussed below.

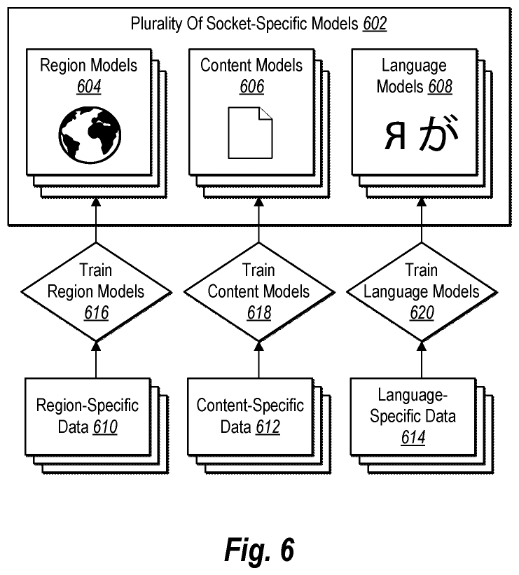

As shown in FIG. 6, the handwriting-recognition pipeline system 102 can train or otherwise fine-tune a plurality of socket-specific models 602 (e.g., different types of models, such as region models 604, content models 606, and language models 608) using region-specific data 610, content-specific data 612, and language-specific data 614 (e.g., using corresponding types of data). For example, the handwriting-recognition pipeline system 102 can perform an act 616 to train region models 604 using the region-specific data 610, an act 618 to train content models 606 using the content-specific data 612, and an act 620 to train language models 608 using the language-specific data 614. In some embodiments, the handwriting-recognition pipeline system 102 can implement an automated process to perform the act 616, the act 618, and the act 620. Further, the handwriting-recognition pipeline system 102 can generate the region-specific data 610, the content-specific data 612, and the language-specific data 614 to be labeled datasets. The handwriting-recognition pipeline system 102 can perform the act 616, the act 618, and the act 620 by providing the corresponding types of data to corresponding models of the plurality of socket-specific models 602, utilizing the plurality of socket-specific models to analyze the corresponding types of data and generate a corresponding output, and modify parameters of the plurality of socket-specific models 602 based on comparing the corresponding outputs to a ground truth to determine a measure of loss.

Indeed, the handwriting-recognition pipeline system 102 can implement an automated process to perform the act 616, the act 618, and/or the act 620 by generating model-type interfaces for each of the different types of models (such as a first model-type interface to autonomously perform the act 616, a second model-type interface to autonomously perform the act 618, and a third model-type interface to autonomously perform the act 620). For example, the handwriting-recognition pipeline system 102 can generate a model-type interface to train or finetune subsets of models within the model type to perform different subsets of tasks of the model-type. For example, the handwriting-recognition pipeline system 102 can utilize the model-type interface to provide subsets of the corresponding types of data to subsets of the model type to train and/or finetune the subsets of the model type to perform the different subsets of tasks.

To illustrate, the handwriting-recognition pipeline system 102 can utilize the second model-type interface to autonomously perform the act 618 by providing subsets of the content-specific data 612 to corresponding subsets of the content models 606 to train the subsets of the content models 606 to perform different types of content-specific tasks, such as by training the subsets of the content models 606 to perform image segmentation for different types of digital images and/or handwriting images (such as birth certificates, journals, court documents, census records, etc.). The handwriting-recognition pipeline system 102 can similarly utilize the first model-type interface to autonomously perform the act 616 and the third model-type interface to autonomously perform the act 620. Accordingly, the handwriting-recognition pipeline system 102 can automate training and/or finetuning of different types of models and can further automate training and/or finetuning of different subsets of models within the model types, to thereby increase the available models for the handwriting-recognition pipeline system 102 to utilize to generate a configurable handwriting-recognition framework.

Moreover, while the foregoing discussion illustrates training specific types of models, such as the region models 604, the content models 606, and the language models 608, the foregoing discussion is intended for illustrative purposes. Indeed, the handwriting-recognition pipeline system 102 can train and/or finetune more or less types of models than depicted in FIG. 6.

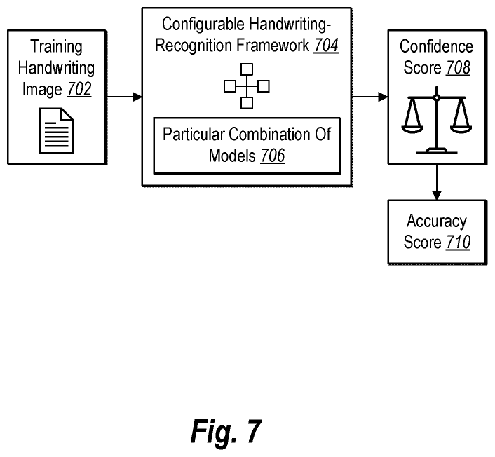

As shown in FIG. 7, the handwriting-recognition pipeline system 102 can determine confidence score 708 for a particular combination of models 706 of a configurable handwriting-recognition framework 704 that the handwriting-recognition pipeline system 102 uses to transcribe a training digital image, such as a training handwriting image 702. Further, the handwriting-recognition pipeline system 102 can use the confidence score 708 to predict an accuracy score 710 for the particular combination of models 706. For example, the handwriting-recognition pipeline system 102 can determine the particular combination of models 706 by inserting one or more candidate socket-specific models into corresponding model sockets of the configurable handwriting-recognition framework 704. In some embodiments, the handwriting-recognition pipeline system 102 can determine the confidence score 708 by selecting or otherwise generating the particular combination of models 706 to be a subset of the configurable handwriting-recognition framework 704. Accordingly, the handwriting-recognition pipeline system 102 can generate the confidence score 708 and the accuracy score 710 for individual models, subsets of the configurable handwriting-recognition framework 704, and/or the configurable handwriting-recognition framework 704.

Indeed, the handwriting-recognition pipeline system 102 can generate the confidence score and the accuracy score 710 in conjunction with training different types of models (e.g., such as performing one or more of the acts 616, 618, and 620 as described above with regard to FIG. 6). Indeed, the handwriting-recognition pipeline system 102 can generate the confidence score 708 by identifying model performance indicators for outputs of each model of the particular combination of models 706. For example, the handwriting-recognition pipeline system 102 can identify the model performance indicators for each model by identifying specific data objects output by each model of the combination of models. In some embodiments, the handwriting-recognition pipeline system 102 generates a confidence score for each data object that the handwriting-recognition pipeline system 102 utilizes the particular combination of models 706 to generate.

The handwriting-recognition pipeline system 102 can further aggregate the confidence scores for the data objects to generate the confidence score 708 to be a model-level confidence score that represents a level of confidence in the data objects that the handwriting-recognition pipeline system 102 utilizes a model of the particular combination of models 706 to generate. In some embodiments, the handwriting-recognition pipeline system 102 can aggregate model-level confidence scores for each model of the combination of models, thus generating the confidence score 708 to be a configurable handwriting-recognition framework-level confidence score 708 that represents a level of confidence in the data objects that the handwriting-recognition pipeline system 102 utilizes the configurable handwriting-recognition framework 704 to generate.

Based on generating the confidence score 708, the handwriting-recognition pipeline system 102 can predict the accuracy score 710. For example, based on generating the confidence score 708 to represent the level of confidence in the data objects that the handwriting-recognition pipeline system 102 utilizes the configurable handwriting-recognition framework 704 to generate, the handwriting-recognition pipeline system 102 can generate the accuracy score 710 to be a prediction of a level of accuracy of the content of the data objects from the configurable handwriting-recognition framework 704. In some embodiments, the handwriting-recognition pipeline system 102 generates the accuracy score 710 to be a model-level prediction of accuracy for outputs of a model of the particular combination of models 706. In some embodiments, the handwriting-recognition pipeline system 102 generates the accuracy score 710 to be a configurable handwriting-recognition framework-level prediction of accuracy for an output of the configurable handwriting-recognition framework 704.

Accordingly, the handwriting-recognition pipeline system 102 can generate the confidence score 708 and the accuracy score 710 in conjunction with automatedly training different types of models as discussed above with regard to FIG. 6. To illustrate, the handwriting-recognition pipeline system 102 can automatedly perform a first round of training on a first type of models (e.g., such as region models). Based on automatedly performing a first round of training and/or finetuning on the first type of models, the handwriting-recognition pipeline system 102 can generate the confidence score 708 and the accuracy score for one or more models of the first type of models. Based on generating the confidence score 708 and the accuracy score 710, the handwriting-recognition pipeline system 102 can automatedly perform a second round of training and/or finetuning on the first type of models and generate a second confidence score and a second accuracy score.

Indeed, the handwriting-recognition pipeline system 102 can iteratively train and/or finetune the first type of models to iteratively generate confidence scores and accuracy scores to identify an accuracy score plateau for the first type of models. Indeed, the handwriting-recognition pipeline system 102 can identify the accuracy score plateau by identifying a training threshold (and/or a finetuning threshold) that indicates that subsequent rounds of training and/or finetuning do not increase subsequent accuracy scores above an accuracy score improvement threshold. Accordingly, the handwriting-recognition pipeline system 102 can automatedly train and/or finetune models and generate the confidence score 708 and the accuracy score 710 at each pass to identify the accuracy score plateau. Based on identifying the accuracy score plateau, the handwriting-recognition pipeline system 102 can determine to stop training the first type of models.

As described above, the handwriting-recognition pipeline system 102 may utilize an audit functionality or process to determine a confidence and/or an accuracy at stages of the handwriting-recognition process. For instance, whereas many existing machine learning ensemble pipelines are opaque and do not offer granular insight into performance of constituent models, in some embodiments, the handwriting-recognition pipeline system 102 uses the audit functionality to advantageously facilitate a determination of confidence at a plurality of intermediate checkpoints, facilitate as necessary rekeying, reevaluation, or other actions in response to, e.g., a below-threshold performance of a constituent model. In embodiments, the handwriting-recognition pipeline system 102 can generate a model-performance indicator (“MPI”) comprising a confidence score pertaining to a particular model's performance. Thus, the handwriting-recognition pipeline system 102 can generate an MPI may for each model socket of a handwriting-recognition pipeline. The MPI may comprise, be associated with, or be compared against a marginal confidence threshold (“MCT”) defining a minimum confidence threshold for a particular MPI. The handwriting-recognition pipeline system 102 can determine the MCT based on a desired accuracy level corresponding to a particular use case. In embodiments, a user may be prompted to set the desired accuracy level when configuring the handwriting-recognition pipeline system 102. Certain use cases can be determined by a user to be more sensitive than others based on the likely impact of the data to be extracted, for example, and in such cases the user may set or be prompted to set the MCT correspondingly higher.

When an MPI for a model does not exceed the defined MCT, the handwriting-recognition pipeline system 102 can trigger a review process, such as review and correction by a vendor, for outputs from the model, whereas model outputs associated with an MPI in excess of the MCT do not cause the handwriting-recognition pipeline system 102 to trigger the review and correction process. In embodiments, the handwriting-recognition pipeline system 102 can utilize a failure confidence threshold (“FCT”) for comparison against the MPI; when the MPI falls below the FCT, the handwriting-recognition pipeline system 102 can determine not to further utilize the output from the model. Additionally, the handwriting-recognition pipeline system 102 can label the input and/or output data to the model for manual, vendor rekey prior to use. The handwriting-recognition pipeline system 102 can determine the FCT in part based on a cost analysis based on vendor rekey rates. Additionally, the handwriting-recognition pipeline system 102 can set the FCT at a threshold where it is more cost effective and/or computationally effective to have the data manually rekeyed by a vendor than to perform further model-based review or hybrid reviews. The handwriting-recognition pipeline system 102 can additionally or alternatively apply and define the MPI, MCT, and FCT.

For instance, where an MPI for a model the handwriting-recognition pipeline system 102 uses falls below the FCT, the handwriting-recognition pipeline system 102 can omit all regions, transcriptions, entities, and relationships pertaining to the image from genealogical records. Where the MPI for a model or pipeline falls between the FCT and MCT, the handwriting-recognition pipeline system 102 can flag the input data, training data, and/or output data for vendor rekey or review prior to utilizing the downstream generated genealogical records. In embodiments, the handwriting-recognition pipeline system 102 can associate every unique MPI with a corresponding MCT and FCT.

In embodiments, the handwriting-recognition pipeline system 102 can define an accuracy to confidence threshold table (“ACT Table”), the ACT Table comprising, in embodiments, a conversion chart or metric facilitating a mapping between accuracy levels and confidence thresholds.

In a particular embodiment, handwriting-recognition pipeline system 102 can configure the layout-detection model to predict a confidence score pertaining to the model's performance, in some cases indicating the layout-detection model's prediction of a failure rate of the images assessed thereby. The handwriting-recognition pipeline system 102 can compare the predicted failure rate against a model-specific, and in some cases use-case-specific, ACT table to determine further dispositions of the assessed images and associated metadata.

In another particular embodiment, the handwriting-recognition pipeline system 102 can configure the componentization model to receive entities generated or predicted by the entity-extraction model. In addition, the handwriting-recognition pipeline system 102 can configure the componentization model to receive, from the entity-extraction model, a confidence metric regarding the predicted entities and to apply an entity-specific confidence threshold or thresholds. For instance, the handwriting-recognition pipeline system 102 can configure the componentization model to determine failed entities, low-confidence entities, and passing entities and to determine therefrom a total failure percentage to compare against the entity-specific confidence threshold.

The handwriting-recognition pipeline system 102 can update the MPI, MCT, FCT, and/or ACT Table for each use case. In embodiments, the handwriting-recognition pipeline system 102 can import the existing MPI, MCT, FCT, and/or ACT Table for a use case may be imported to a similar or analogous use case and fine-tuned by a user or by the genealogical data system.

By defining an MPI for each model and optionally for the entire pipeline, it has been surprisingly found that distinct workflows may be established and operated for data of different confidence levels. For example, high-confidence entities and other data can be processed without further review whereas lower-confidence entities and other data can be processed in a separate workflow via additional review and rekey procedures and/or manual rekey processes. This advantageously reduces the costs associated with generating genealogical records, as the expenses associated with additional review and rekey procedures are only invoked where MPIs indicate that certain data would indeed benefit from such procedures.

In certain embodiments, the handwriting-recognition pipeline system 102 provides via a user interface or otherwise a volume and/or cost of data processed through the handwriting-recognition pipeline system 102. In embodiments, this may be provided in conjunction with metrics regarding an accuracy and/or a confidence of predictions made by the handwriting-recognition pipeline system 102. This advantageously allows a user, who may not be a trained data scientist, to iteratively adapt the handwriting-recognition pipeline system 102 to the needs and budget of their use case.

Further, by providing an audit functionality as described herein, a machine learning ensemble may realize increased accuracy and lower overall costs, as errors generated by a model early in the pipeline can be identified before those errors propagate through downstream models in a manner that confounds results and confounds troubleshooting efforts by a user, reducing the amount of training and oversight required to get desired output, e.g. genealogical records.

FIG. 8 illustrates a genealogical-data system 800 (e.g., the genealogical-data system 106) that the handwriting-recognition pipeline system 102 uses to store and/or organize genealogical data. For example, the handwriting-recognition pipeline system 102 can receive genealogical data (e.g., genealogical records and/or genealogical data objects) from a source selected from the group consisting of the Ancestry World Tree system, a Social Security Death Index database, the World Family Tree system, a birth certificate database, a death certificate database, a marriage certificate database, an adoption database, a draft registration database, a veterans database, a military database, a property records database, a census database, a voter registration database, a phone database, an address database, a newspaper database, an immigration database, a family history records database, a local history records database, a business registration database, and a motor vehicle database. Additionally, the handwriting-recognition pipeline system 102 can receive user-generated genealogical data. Further, the handwriting-recognition pipeline system 102 can receive or otherwise extract genealogical data from a clustered database derived from records and user data.

In some embodiments of the handwriting-recognition pipeline system 102 can modify a cluster database, such as when the handwriting-recognition pipeline system 102 identifies a new genealogical relationship from a genealogical record (e.g., based on an identification of a previously unknown person, such as from a genealogical record the handwriting-recognition pipeline system 102 generates from a handwriting image). In some instances, the handwriting-recognition pipeline system 102 can generate a node connection between two nodes corresponding to the two persons in different trees. The handwriting-recognition pipeline system 102 can implement this approach iteratively during the generation of the cluster database. Thus, as the handwriting-recognition pipeline system 102 creates a new node or edits an existing node, the handwriting-recognition pipeline system 102 can check whether that node resolves to a current entity cluster or whether it should generate its own cluster (e.g., such as in response to identifying a new genealogical relationship). Additionally, this technique may be used as users utilize the ancestor-identification embodiments to generate new nodes in their own tree based on an identification of a previously unknown person from an image based on a match identified in an existing node of an existing tree and/or cluster.

As seen in FIG. 8, the genealogical-data system 800 includes a genealogical database 802, which may include a tree database 812 and a cluster database 814. The tree database 812 may be configured to facilitate the generation, storage, and collation of family trees for a plurality of users, with trees comprising nodes and edges therebetween. Data and records, such as images, may be associated with individual nodes of the trees in the tree database 812. Tree person data, including data such as names, relationships, dates, events, and other metadata may be provided by the tree database 812 to the genealogical-data system 800. The cluster database 814 may include one or more clusters comprising resolved entities, where tree persons (nodes) in different trees in the tree database 812 are associated together in a cluster after determination that the tree persons correspond to a same person.

As the handwriting-recognition pipeline system 102 expands a family tree of a user account, (e.g. by identifying new genealogical relationships from genealogical records the handwriting-recognition pipeline system 102 generates), the handwriting-recognition pipeline system 102 can additionally modify the tree database 812 to reflect changes to the family tree. Further, the handwriting-recognition pipeline system 102 can modify the cluster database 814 to include a new node in the pertinent cluster corresponding to the new genealogical relationship. Further, the handwriting-recognition pipeline system 102 can attach a genealogical record (e.g., that the handwriting-recognition pipeline system 102 generates from a digital image) to a cluster within the cluster database 814 and/or a node within the tree database 812 to utilize as a ground-truth genealogy tree for future operations within the genealogical-data system 800.

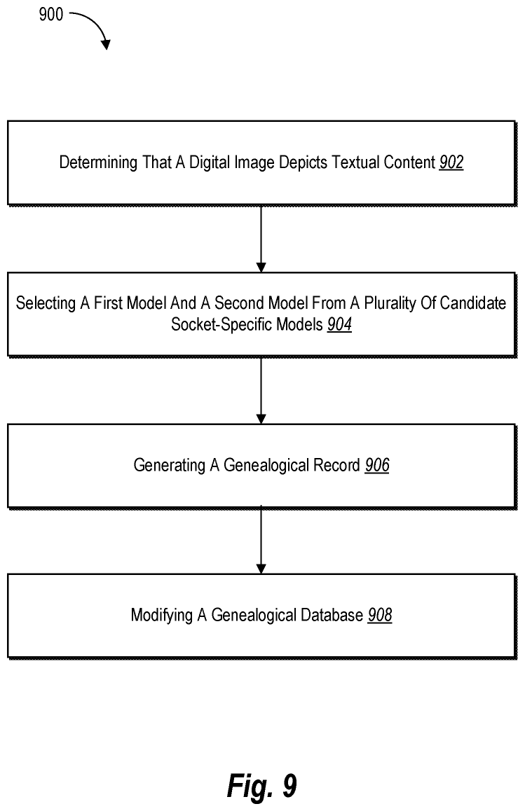

FIGS. 1-8 the corresponding text, and the examples provide a number of different systems and methods for generating responses using a handwriting-recognition pipeline system in accordance with one or more embodiments. In addition to the foregoing, implementations can also be described in terms of flowcharts comprising acts steps in a method for accomplishing a particular result. For example, FIG. 9 illustrates an example series of acts for generating a genealogical record using a handwriting-recognition pipeline system.

While FIG. 9 illustrates acts according to certain implementations, alternative implementations may omit, add to, reorder, and/or modify any of the acts shown in FIG. 9. The acts of FIG. 9 can be performed as part of a computer-implemented method. Alternatively, a non-transitory computer-readable medium can comprise instructions, that when executed by one or more processors, cause a computing device to perform the acts of FIG. 9. In still further implementations, a system can perform the acts of FIG. 9.

As illustrated, the series of acts 900 can include an act 902 of determining that a digital image depicts textual content. In particular, the act 902 can include determining, utilizing an image-classification model of a configurable handwriting-recognition framework comprising a plurality of model sockets, that a digital image depicts textual content. Further, the series of acts 900 can include an act 904 of selecting a first model and a second model from a plurality of candidate model socket-specific models. Specifically, the act 904 can include selecting, from a plurality of candidate model socket-specific models adaptable to the plurality of model sockets within the configurable handwriting-recognition framework, a first model compatible with a first model socket of the plurality of model sockets within the configurable handwriting-recognition framework; a first model compatible with a first model socket of the plurality of model sockets to execute a first function on the digital image; and a second model compatible with a second model socket of the plurality of model sockets and comprising input parameters adapted to output parameters of the first model. In some embodiments, the series of acts 900 can include an act 906 of generating a genealogical record. Specifically, the act 906 can include generating, utilizing the second model, a genealogical record from an output of the first model. Additionally, the series of acts 900 can include an act 908 of modifying a genealogical database. Specifically, the act 908 can include modifying a genealogical database utilizing the genealogical record.

For example, the series of acts 900 can include acts to perform any of the operations described in the following clauses:

CLAUSE 1. A computer-implemented method, comprising:
determining, utilizing an image-classification model of a configurable handwriting-recognition framework comprising a plurality of model sockets, that a digital image depicts textual content;
selecting, from a plurality of candidate model socket-specific models adaptable to the plurality of model sockets within the configurable handwriting-recognition framework:
   a first model compatible with a first model socket of the plurality of model sockets to execute a first function on the digital image; and
   a second model compatible with a second model socket of the plurality of model sockets and comprising input parameters adapted to output parameters of the first model;
generating, utilizing the second model, a genealogical record from an output of the first model; and
modifying a genealogical database utilizing the genealogical record.

CLAUSE 2. The computer-implemented method of clause 1, further comprising providing a framework-configuration interface for display on a client device, the framework-configuration interface comprising selectable elements for configuring models within the configurable handwriting-recognition framework.

CLAUSE 3. The computer-implemented method of any of clauses 1-2, further comprising modifying the configurable handwriting-recognition framework responsive to receiving an indication of a model of the plurality of candidate model socket-specific models within the framework-configuration interface.

CLAUSE 4. The computer-implemented method of any of clauses 1-3, further comprising:
receiving a selection of a first model-socket element representing the first model socket within the framework-configuration interface; and
inserting the first model into the first model socket based on receiving an input to add the first model to the first model socket within the framework-configuration interface.

CLAUSE 5. The computer-implemented method of any of clauses 1-4, wherein the first model socket comprises a layout-detection model socket and the second model socket comprises a transcription model socket.

CLAUSE 6. The computer-implemented of any of clauses 1-5, further comprising generating the configurable handwriting-recognition framework to include a model socket corresponding to an entity-extraction model and a model socket corresponding to a relationship-extraction model.

CLAUSE 7. The computer-implemented of any of clauses 1-6, wherein the configurable handwriting-recognition framework further comprises model-socket adapters that connect the plurality of model sockets and that standardize inputs and outputs of models inserted into the plurality of model sockets.

CLAUSE 8. The computer-implemented method of any of clauses 1-7, further comprising, based on determining that the digital image depicts the textual content, automatically generating the configurable handwriting-recognition framework by selecting models from the plurality of candidate model socket-specific models that correspond to model sockets of the plurality of model sockets.

CLAUSE 9. The computer-implemented method of any of clauses 1-8, further comprising fine-tuning a plurality of subsets of the plurality of candidate model socket-specific models according to a plurality of types of digital image data, wherein the plurality of types of digital image data comprise region-specific data, content-specific data, or language-specific data.

CLAUSE 10. The computer-implemented method of any of clauses 1-9, further comprising:
determining a confidence score for a training genealogical record generated from a training digital image of a first type, wherein the training digital image depicts textual content; and
determining, based on the confidence score, an accuracy score that predicts an accuracy for genealogical records generated from digital images of the first type using a particular combination of models inserted into the plurality of model sockets of the configurable handwriting-recognition framework.

Embodiments of the present disclosure may comprise or utilize a special purpose or general-purpose computer including computer hardware, such as, for example, one or more processors and system memory, as discussed in greater detail below. Implementations within the scope of the present disclosure also include physical and other computer-readable media for carrying or storing computer-executable instructions and/or data structures. In particular, one or more of the processes described herein may be implemented at least in part as instructions embodied in a non-transitory computer-readable medium and executable by one or more computing devices (e.g., any of the media content access devices described herein). In general, a processor (e.g., a microprocessor) receives instructions, from a non-transitory computer-readable medium, (e.g., a memory, etc.), and executes those instructions, thereby performing one or more processes, including one or more of the processes described herein.

Computer-readable media can be any available media that can be accessed by a general purpose or special purpose computer system. Computer-readable media that store computer-executable instructions are non-transitory computer-readable storage media (devices). Computer-readable media that carry computer-executable instructions are transmission media. Thus, by way of example, and not limitation, implementations of the disclosure can comprise at least two distinctly different kinds of computer-readable media: non-transitory computer-readable storage media (devices) and transmission media.

Non-transitory computer-readable storage media (devices) includes RAM, ROM, EEPROM, CD-ROM, solid state drives (“SSDs”) (e.g., based on RAM), Flash memory, phase-change memory (“PCM”), other types of memory, other optical disk storage, magnetic disk storage or other magnetic storage devices, or any other medium which can be used to store desired program code means in the form of computer-executable instructions or data structures and which can be accessed by a general purpose or special purpose computer.

A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmissions media can include a network and/or data links which can be used to carry desired program code means in the form of computer-executable instructions or data structures and which can be accessed by a general purpose or special purpose computer. Combinations of the above should also be included within the scope of computer-readable media.

Further, upon reaching various computer system components, program code means in the form of computer-executable instructions or data structures can be transferred automatically from transmission media to non-transitory computer-readable storage media (devices) (or vice versa). For example, computer-executable instructions or data structures received over a network or data link can be buffered in RAM within a network interface module (e.g., a “NIC”), and then eventually transferred to computer system RAM and/or to less volatile computer storage media (devices) at a computer system. Thus, it should be understood that non-transitory computer-readable storage media (devices) can be included in computer system components that also (or even primarily) utilize transmission media.

Computer-executable instructions comprise, for example, instructions and data which, when executed by a processor, cause a general-purpose computer, special purpose computer, or special purpose processing device to perform a certain function or group of functions. In some implementations, computer-executable instructions are executed on a general-purpose computer to turn the general-purpose computer into a special purpose computer implementing elements of the disclosure. The computer executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the disclosure may be practiced in network computing environments with many types of computer system configurations, including, personal computers, desktop computers, laptop computers, message processors, hand-held devices, multiprocessor systems, microprocessor-based or programmable consumer electronics, network PCs, minicomputers, mainframe computers, mobile telephones, PDAs, tablets, pagers, routers, switches, and the like. The disclosure may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

Implementations of the present disclosure can also be implemented in cloud computing environments. In this description, “cloud computing” is defined as a model for enabling on-demand network access to a shared pool of configurable computing resources. For example, cloud computing can be employed in the marketplace to offer ubiquitous and convenient on-demand access to the shared pool of configurable computing resources. The shared pool of configurable computing resources can be rapidly provisioned via virtualization and released with low management effort or service provider interaction, and then scaled accordingly.

A cloud-computing model can be composed of various characteristics such as, for example, on-demand self-service, broad network access, resource pooling, rapid elasticity, measured service, and so forth. A cloud-computing model can also expose various service models, such as, for example, Software as a Service (“SaaS”), Platform as a Service (“PaaS”), and Infrastructure as a Service (“IaaS”). A cloud-computing model can also be deployed using different deployment models such as private cloud, community cloud, public cloud, hybrid cloud, and so forth. In this description and in the claims, a “cloud-computing environment” is an environment in which cloud computing is employed.

FIG. 10 illustrates a block diagram of exemplary computing device 1000 (e.g., the server(s) 104 and/or the client device 108) that may be configured to perform one or more of the processes described above. One will appreciate that server(s) 104 and/or the client device 108 may comprise one or more computing devices such as computing device 1000. As shown by FIG. 10, computing device 1000 can comprise processor 1002, memory 1004, storage device 1006, I/O interface 1008, and communication interface 1010, which may be communicatively coupled by way of communication infrastructure 1012. While an exemplary computing device 1000 is shown in FIG. 10, the components illustrated in FIG. 10 are not intended to be limiting. Additional or alternative components may be used in other implementations. Furthermore, in certain implementations, computing device 1000 can include fewer components than those shown in FIG. 10. Components of computing device 1000 shown in FIG. 10 will now be described in additional detail.

In particular implementations, processor 1002 includes hardware for executing instructions, such as those making up a computer program. As an example and not by way of limitation, to execute instructions, processor 1002 may retrieve (or fetch) the instructions from an internal register, an internal cache, memory 1004, or storage device 1006 and decode and execute them. In particular implementations, processor 1002 may include one or more internal caches for data, instructions, or addresses. As an example and not by way of limitation, processor 1002 may include one or more instruction caches, one or more data caches, and one or more translation lookaside buffers (TLBs). Instructions in the instruction caches may be copies of instructions in memory 1004 or storage device 1006.

Memory 1004 may be used for storing data, metadata, and programs for execution by the processor(s). Memory 1004 may include one or more of volatile and non-volatile memories, such as Random Access Memory (“RAM”), Read Only Memory (“ROM”), a solid state disk (“SSD”), Flash, Phase Change Memory (“PCM”), or other types of data storage. Memory 1004 may be internal or distributed memory.

Storage device 1006 includes storage for storing data or instructions. As an example and not by way of limitation, storage device 1006 can comprise a non-transitory storage medium described above. Storage device 1006 may include a hard disk drive (HDD), a floppy disk drive, flash memory, an optical disc, a magneto-optical disc, magnetic tape, or a Universal Serial Bus (USB) drive or a combination of two or more of these. Storage device 1006 may include removable or non-removable (or fixed) media, where appropriate. Storage device 1006 may be internal or external to computing device 1000. In particular implementations, storage device 1006 is non-volatile, solid-state memory. In other implementations, Storage device 1006 includes read-only memory (ROM). Where appropriate, this ROM may be mask programmed ROM, programmable ROM (PROM), erasable PROM (EPROM), electrically erasable PROM (EEPROM), electrically alterable ROM (EAROM), or flash memory or a combination of two or more of these.

I/O interface 1008 allows a user to provide input to, receive output from, and otherwise transfer data to and receive data from computing device 1000. I/O interface 1008 may include a mouse, a keypad or a keyboard, a touch screen, a camera, an optical scanner, network interface, modem, other known I/O devices or a combination of such I/O interfaces. I/O interface 1008 may include one or more devices for presenting output to a user, including, but not limited to, a graphics engine, a display (e.g., a display screen), one or more output drivers (e.g., display drivers), one or more audio speakers, and one or more audio drivers. In certain implementations, I/O interface 1008 is configured to provide graphical data to a display for presentation to a user. The graphical data may be representative of one or more graphical user interfaces and/or any other graphical content as may serve a particular implementation.

Communication interface 1010 can include hardware, software, or both. In any event, communication interface 1010 can provide one or more interfaces for communication (such as, for example, packet-based communication) between computing device 1000 and one or more other computing devices or networks. As an example and not by way of limitation, communication interface 1010 may include a network interface controller (NIC) or network adapter for communicating with an Ethernet or other wire-based network or a wireless NIC (WNIC) or wireless adapter for communicating with a wireless network, such as a WI-FI.

Additionally or alternatively, communication interface may facilitate communications with an ad hoc network, a personal area network (PAN), a local area network (LAN), a wide area network (WAN), a metropolitan area network (MAN), or one or more portions of the Internet or a combination of two or more of these. One or more portions of one or more of these networks may be wired or wireless. As an example, communication interface 1010 may facilitate communications with a wireless PAN (WPAN) (such as, for example, a BLUETOOTH WPAN), a WI-FI network, a WI-MAX network, a cellular telephone network (such as, for example, a Global System for Mobile Communications (GSM) network), or other suitable wireless network or a combination thereof.

Additionally, communication interface 1010 may facilitate communications various communication protocols. Examples of communication protocols that may be used include, but are not limited to, data transmission media, communications devices, Transmission Control Protocol (“TCP”), Internet Protocol (“IP”), File Transfer Protocol (“FTP”), Telnet, Hypertext Transfer Protocol (“HTTP”), Hypertext Transfer Protocol Secure (“HTTPS”), Session Initiation Protocol (“SIP”), Simple Object Access Protocol (“SOAP”), Extensible Mark-up Language (“XML”) and variations thereof, Simple Mail Transfer Protocol (“SMTP”), Real-Time Transport Protocol (“RTP”), User Datagram Protocol (“UDP”), Global System for Mobile Communications (“GSM”) technologies, Code Division Multiple Access (“CDMA”) technologies, Time Division Multiple Access (“TDMA”) technologies, Short Message Service (“SMS”), Multimedia Message Service (“MMS”), radio frequency (“RF”) signaling technologies, Long Term Evolution (“LTE”) technologies, wireless communication technologies, in-band and out-of-band signaling technologies, and other suitable communications networks and technologies.

Communication infrastructure 1012 may include hardware, software, or both that couples components of computing device 1000 to each other. As an example and not by way of limitation, communication infrastructure 1012 may include an Accelerated Graphics Port (AGP) or other graphics bus, an Enhanced Industry Standard Architecture (EISA) bus, a front-side bus (FSB), a HYPERTRANSPORT (HT) interconnect, an Industry Standard Architecture (ISA) bus, an INFINIBAND interconnect, a low-pin-count (LPC) bus, a memory bus, a Micro Channel Architecture (MCA) bus, a Peripheral Component Interconnect (PCI) bus, a PCI-Express (PCIe) bus, a serial advanced technology attachment (SATA) bus, a Video Electronics Standards Association local (VLB) bus, or another suitable bus or a combination thereof.

Although this disclosure describes certain exemplary embodiments and examples of a handwriting-recognition pipeline system, computer program product, and/or method, it nevertheless will be understood by those skilled in the art that the present disclosure extends beyond the specifically disclosed embodiments to other alternative embodiments and/or uses of the disclosure and obvious modifications and equivalents thereof. It is intended that the scope of the present disclosure should not be limited by the particular disclosed embodiments described above, and may be extended to other uses, approaches, and contexts of family tree-, genealogy-, and/or genetic-related applications.

FIG. 11 is a schematic diagram illustrating environment 1100 within which one or more implementations of the handwriting-recognition pipeline system 102 can be implemented. For example, the handwriting-recognition pipeline system 102 may be part of a genealogical-data system 1102 (e.g., the genealogical-data system 1102). The genealogical-data system 1102 may generate, store, manage, receive, and send digital content (such as genealogical records). For example, genealogical-data system 1102 may send and receive digital content to and from client devices 1106 by way of network 1104. In particular, genealogical-data system 1102 can store and manage genealogical databases for various user accounts, historical records, and genealogy trees. In some embodiments, the genealogical-data system 1102 can manage the distribution and sharing of digital content between computing devices associated with user accounts. For instance, the genealogical-data system 1102 can facilitate a user account sharing a genealogical record with another user account of genealogical-data system 1102.

In particular, the genealogical-data system 1102 can manage synchronizing digital content across multiple client devices 1106 associated with one or more user accounts. For example, a user may edit a digitized historical document or a node within a genealogy tree using client device 1106. The genealogical-data system 1102 can cause client device 1106 to send the edited genealogical content to the genealogical-data system 1102, whereupon the genealogical-data system 1102 synchronizes the genealogical content on one or more additional computing devices.

As shown, the client device 1106 may be a desktop computer, a laptop computer, a tablet computer, an augmented reality device, a virtual reality device, a personal digital assistant (PDA), an in- or out-of-car navigation system, a handheld device, a smart phone or other cellular or mobile phone, or a mobile gaming device, other mobile device, or other suitable computing devices. The client device 1106 may execute one or more client applications, such as a web browser (e.g., Microsoft Windows Internet Explorer, Mozilla Firefox, Apple Safari, Google Chrome, Opera, etc.) or a native or special-purpose client application (e.g., Ancestry: Family History & DNA for iPhone or iPad, Ancestry: Family History & DNA for Android, etc.), to access and view content over the network 1104.

The network 1104 may represent a network or collection of networks (such as the Internet, a corporate intranet, a virtual private network (VPN), a local area network (LAN), a wireless local area network (WLAN), a cellular network, a wide area network (WAN), a metropolitan area network (MAN), or a combination of two or more such networks) over which client devices 1106 may access genealogical-data system 1102.

In the foregoing specification, the present disclosure has been described with reference to specific exemplary implementations thereof. Various implementations and aspects of the present disclosure(s) are described with reference to details discussed herein, and the accompanying drawings illustrate the various implementations. The description above and drawings are illustrative of the disclosure and are not to be construed as limiting the disclosure. Numerous specific details are described to provide a thorough understanding of various implementations of the present disclosure.

The present disclosure may be embodied in other specific forms without departing from its spirit or essential characteristics. The described implementations are to be considered in all respects only as illustrative and not restrictive. For example, the methods described herein may be performed with less or more steps/acts or the steps/acts may be performed in differing orders. Additionally, the steps/acts described herein may be repeated or performed in parallel with one another or in parallel with different instances of the same or similar steps/acts. The scope of the present application is, therefore, indicated by the appended claims rather than by the foregoing description. All changes that come within the meaning and range of equivalency of the claims are to be embraced within their scope.

The foregoing specification is described with reference to specific exemplary implementations thereof. Various implementations and aspects of the disclosure are described with reference to details discussed herein, and the accompanying drawings illustrate the various implementations. The description above and drawings are illustrative and are not to be construed as limiting. Numerous specific details are described to provide a thorough understanding of various implementations.

The additional or alternative implementations may be embodied in other specific forms without departing from its spirit or essential characteristics. The described implementations are to be considered in all respects only as illustrative and not restrictive. The scope of the invention is, therefore, indicated by the appended claims rather than by the foregoing description. All changes that come within the meaning and range of equivalency of the claims are to be embraced within their scope.

What is claimed is:

1. A computer-implemented method comprising:
determining, utilizing an image-classification model of a configurable handwriting-recognition framework comprising a plurality of model sockets, that a digital image depicts textual content;
selecting, from a plurality of candidate model socket-specific models adaptable to the plurality of model sockets within the configurable handwriting-recognition framework:
a first model compatible with a first model socket of the plurality of model sockets to execute a first function on the digital image; and
a second model compatible with a second model socket of the plurality of model sockets and comprising input parameters adapted to output parameters of the first model;
generating, utilizing the second model, a genealogical record from an output of the first model; and
modifying a genealogical database utilizing the genealogical record.

2. The computer-implemented method of claim 1, further comprising providing a framework-configuration interface for display on a client device, the framework-configuration interface comprising selectable elements for configuring models within the configurable handwriting-recognition framework.

3. The computer-implemented method of claim 2, further comprising modifying the configurable handwriting-recognition framework responsive to receiving an indication of a model of the plurality of candidate model socket-specific models within the framework-configuration interface.

4. The computer-implemented method of claim 3, further comprising:
receiving a selection of a first model-socket element representing the first model socket within the framework-configuration interface; and
inserting the first model into the first model socket based on receiving an input to add the first model to the first model socket within the framework-configuration interface.

5. The computer-implemented method of claim 1, wherein the first model socket comprises a layout-detection model socket and the second model socket comprises a transcription model socket.

6. The computer-implemented method of claim 5, further comprising generating the configurable handwriting-recognition framework to include a model socket corresponding to an entity-extraction model and a model socket corresponding to a relationship-extraction model.

7. The computer-implemented method of claim 1, wherein the configurable handwriting-recognition framework further comprises model-socket adapters that connect the plurality of model sockets and that standardize inputs and outputs of models inserted into the plurality of model sockets.

8. The computer-implemented method of claim 1, further comprising:
based on determining that the digital image depicts the textual content, automatically generating the configurable handwriting-recognition framework by selecting models from the plurality of candidate model socket-specific models that correspond to model sockets of the plurality of model sockets.

9. The computer-implemented method of claim 1, further comprising fine-tuning a plurality of subsets of the plurality of candidate model socket-specific models according to a plurality of types of digital image data, wherein the plurality of types of digital image data comprise region-specific data, content-specific data, or language-specific data.

10. The computer-implemented method of claim 1, further comprising:
determining a confidence score for a training genealogical record generated from a training digital image of a first type, wherein the training digital image depicts textual content; and
determining, based on the confidence score, an accuracy score that predicts an accuracy for genealogical records generated from digital images of the first type using a particular combination of models inserted into the plurality of model sockets of the configurable handwriting-recognition framework.

11. A system comprising:
at least one processor; and
at least one non-transitory computer-readable storage medium storing instructions that, when executed by the at least one processor, cause the system to:
determine, utilizing an image-classification model of a configurable handwriting-recognition framework comprising a plurality of model sockets, that a digital image depicts textual content;
select, from a plurality of candidate model socket-specific models adaptable to the plurality of model sockets within the configurable handwriting-recognition framework:
a first model compatible with a first model socket of the plurality of model sockets to execute a first function on the digital image; and
a second model compatible with a second model socket of the plurality of model sockets and comprising input parameters adapted to output parameters of the first model;
generate, utilizing the second model, a genealogical record from an output of the first model; and
modify a genealogical database utilizing the genealogical record.

12. The system of claim 11, further comprising instructions that, when executed by the at least one processor, cause the system to provide a framework-configuration interface for display on a client device, the framework-configuration interface comprising selectable elements for configuring models within the configurable handwriting-recognition framework.

13. The system of claim 12, further comprising instructions that, when executed by the at least one processor, cause the system to modify the configurable handwriting-recognition framework responsive to receiving an indication of a model of the plurality of candidate model socket-specific models within the framework-configuration interface.

14. The system of claim 13, further comprising instructions that, when executed by the at least one processor, cause the system to:
receive a selection of a first model-socket element representing the first model socket within the framework-configuration interface; and
insert the first model into the first model socket based on receiving an input to add the first model to the first model socket within the framework-configuration interface.

15. The system of claim 11, wherein the first model socket comprises a layout-detection model socket and the second model socket comprises a transcription model socket.

16. The system of claim 15, further comprising instructions that, when executed by the at least one processor, cause the system to generate the configurable handwriting-recognition framework to include a model socket corresponding to an entity-extraction model and a model socket corresponding to a relationship-extraction model.

17. A non-transitory computer-readable medium storing instructions that, when executed by at least one processor, cause a computing device to:
determine, utilizing an image-classification model of a configurable handwriting-recognition framework comprising a plurality of model sockets, that a digital image depicts textual content;
select, from a plurality of candidate model socket-specific models adaptable to the plurality of model sockets within the configurable handwriting-recognition framework:
a first model compatible with a first model socket of the plurality of model sockets to execute a first function on the digital image; and
a second model compatible with a second model socket of the plurality of model sockets and comprising input parameters adapted to output parameters of the first model;
generate, utilizing the second model, a genealogical record from an output of the first model; and
modify a genealogical database utilizing the genealogical record.

18. The non-transitory computer-readable medium of claim 17, wherein the configurable handwriting-recognition framework further comprises model-socket adapters that connect the plurality of model sockets and that standardize inputs and outputs of models inserted into the plurality of model sockets.

19. The non-transitory computer-readable medium of claim 18, further comprising instructions that, when executed by the at least one processor, cause the computing device to, based on determining that the digital image depicts the textual content, automatically generate the configurable handwriting-recognition framework by selecting models from the plurality of candidate model socket-specific models that correspond to model sockets of the plurality of model sockets.

20. The non-transitory computer-readable medium of claim 17, further comprising instructions that, when executed by the at least one processor, cause the computing device to fine-tune a plurality of subsets of the plurality of candidate model socket-specific models according to a plurality of types of digital image data, wherein the plurality of types of digital image data comprise region-specific data, content-specific data, or language-specific data.
